(19) United States
(12) Patent Application Publication
(10) Pub. No.: US 2019/0087128 A1
(43) Pub. Date: Mar. 21, 2019

(54) MEMORY SYSTEM AND OPERATING METHOD OF THE SAME

(71) Applicant: SK hynix Inc., Gyeonggi-do (KR)

(72) Inventor: Beom-Ju SHIN, Gyeonggi-do (KR)

(21) Appl. No.: 15/957,619

(22) Filed: Apr. 19, 2018

(30) Foreign Application Priority Data
Sep. 18, 2017 (KR) 10-2017-0119425

(51) Int. Cl. G06F 3/06; G06F 12/06

(52) U.S. Cl. CPC G06F 3/0659; G06F 3/0613; G06F 3/064; G06F 2212/1016; G06F 3/0652; G06F 12/0607; G06F 3/0673

(57) ABSTRACT

A memory system includes a memory device including blocks each having pages, planes each having the blocks and dies each having the planes; and a controller for managing the blocks grouped in units of super blocks, wherein the controller includes command queues in which commands for controlling command operations of the dies are stored, and when an erase operation is performed on a second super block in a time period where a program operation including “M” super block page unit program operations is performed on a first super block, divided erase commands obtained by dividing erase commands for the second super block in units of dies are distributed and stored in locations corresponding to discontinuous “N” moments among successive M+1 moments so that the erase operation is distributed and performed on the second super block at the discontinuous “N” moments by being divided in units of dies.

### CROSS-REFERENCE TO RELATED APPLICATIONS

The present application claims priority to Korean Patent Application No. 10-2017-0119425, filed on Sep. 18, 2017, which is incorporated herein by reference in its entirety.

### BACKGROUND

### 1. Field

Various exemplary embodiments of the present invention relate to a memory system and, more particularly, to a memory system capable of processing data to and from a memory device, and an operating method thereof.

### 2. Description of the Related Art

The computer environment paradigm has changed to ubiquitous computing systems that can be used anytime and anywhere. Due to this fact, use of portable electronic devices such as mobile phones, digital cameras, and notebook computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts. Examples of memory systems having such advantages include universal serial bus (USB) memory devices, memory cards having various interfaces, and solid state drives (SSD).

### SUMMARY

Various embodiments of the present invention are directed to a memory system capable of supporting an effective erase operation under a super memory block situation, and an operating method of the memory system.

In accordance with an embodiment of the present invention, a memory system includes: a memory device including a plurality of blocks each having a plurality of pages, a plurality of planes each having the blocks and a plurality of dies each having the planes; and a controller suitable for managing the blocks grouped into a manner corresponding to a predetermined condition in units of super blocks, wherein the controller includes a plurality of command queues in which commands for controlling command operations of the respective dies are stored, and when an erase operation is performed on a second super block in a time period where a program operation including “M” super block page unit program operations is performed on a first super block, divided erase commands obtained by dividing erase commands for the second super block in units of dies are distributed and stored in locations corresponding to discontinuous “N” moments among successive M+1 moments so that the erase operation is distributed and performed on the second super block at the discontinuous “N” moments by being divided in units of dies, and each of “M” and “N” is a natural number equal to or greater than 2, and “M” is greater than “N”,

The controller may distribute the divided erase commands in parallel between M program commands corresponding to the “M” super block page unit program operations included in the program operation of the first super block so as to correspond to the “N” moments and then store the divided erase commands in the command queues so that the erase operation of the second super block divided in units of dies is distributed and performed in parallel between the “N” moments in the time period where the “M” super block page unit program operations included in the program operation of the first super block are performed at the M+1 moments.

The controller may operate the dies in a first predetermined order through an interleaving scheme, and wherein the controller distributes the divided erase commands in parallel between the “M” program commands so as to correspond to the first predetermined order and the “N” moments and then stores the divided erase commands in the command queues.

The controller may manage a second predetermined order of the command queues in which the smallest number of commands to the greatest number of commands are stored, and wherein the controller distributes the divided erase commands in parallel between the “M” program commands so as to correspond to the second predetermined order and the “N” moments and then stores the divided erase commands in the command queues.

The controller may manage a third predetermined order of the command queues whose expected time required for carrying out the commands is ranging from the shortest one to the longest one, and wherein the controller distributes the divided erase commands in parallel between the “M” program commands so as to correspond to the third predetermined order and the “N” moments and then stores the divided erase commands in the command queues.

The controller may manage a fourth predetermined order of dies in which the greatest number of pages to the smallest number of pages are programmed among the dies, and wherein the controller distributes the divided erase commands in parallel between the M program commands so as to correspond to the fourth predetermined order and the N moments and then stores the divided erase commands in the command queues.

A first die among the dies may be coupled to a first channel, a second die among the dies may be coupled to a second channel, first planes included in the first die may be coupled to a plurality of first ways sharing the first channel with each other, and second planes included in the second die may be coupled to a plurality of second ways sharing the second channel with each other.

The controller may include grouping a first block included in a first plane among the first planes of the first die and a second block included in a second plane among the first planes of the first die and grouping a third block included in a third plane among the second planes of the second die and a fourth block included in a fourth plane among the second planes of the second die in the predetermined condition.

The controller may include grouping a first block included in a first plane among the first planes of the first die and a second block included in a second plane among the second planes of the second die and grouping a third block included in a third plane among the first planes of the first die and a fourth block included in a fourth plane among the second planes of the second die in the predetermined condition.

The controller may include grouping a first block included in a first plane among the first planes of the first die, a second block included in a second plane among the first planes of the first die, a third block included in a third plane among the second planes of the second die and a fourth block included in a fourth plane among the second planes of the second die in the predetermined condition.

An operating method for a memory system including a memory device that includes a plurality of blocks each having a plurality of pages, a plurality of planes each having the blocks and a plurality of dies each having the planes and a plurality of command queues in which commands for controlling command operations of the respective dies are stored, the operating method includes: managing the blocks grouped into a manner corresponding to a predetermined condition in units of super blocks; and distributing and storing divided erase commands obtained by dividing erase commands for the second super block in units of dies in locations corresponding to discontinuous “N” moments among successive M+1 moments so that an erase operation is distributed and performed on a second super block at the discontinuous N moments by being divided in units of dies when the erase operation is performed on the second super block in a time period where a program operation including “M” super block page unit program operations is performed on a first super block, wherein each of “M” and “N” is a natural number equal to or greater than 2, and “M” is greater than “N”.

The distributing and storing of the divided erase commands may include distributing the divided erase commands in parallel between “M” program commands corresponding to the “M” super block page unit program operations included in the program operation of the first super block so as to correspond to the “N” moments and then storing the divided erase commands in the command queues so that the erase operation of the second super block divided in units of dies is distributed and performed in parallel between the “N” moments in the time period where the “M” super block page unit program operations included in the program operation of the first super block are performed at the M+1 moments.

The operating method may further include: operating the dies in a first predetermined order through an interleaving scheme, and wherein the distributing and storing of the divided erase commands includes distributing the divided erase commands in parallel between the “M” program commands so as to correspond to the first predetermined order and the “N” moments and then storing the divided erase commands in the command queues.

The operating method may further include: managing a second predetermined order of the command queues in which the smallest number of commands to the greatest number of commands are stored, and wherein the distributing and storing of the divided erase commands includes distributing the divided erase commands in parallel between the “M” program commands so as to correspond to the second predetermined order and the “N” moments and then storing the divided erase commands in the command queues.

The operating method may further include: managing a third predetermined order of the command queues whose expected time required for carrying out the commands is ranging from the shortest one to the longest one, and wherein the distributing and storing of the divided erase commands includes distributing the divided erase commands in parallel between the “M” program commands so as to correspond to the third predetermined order and the “N” moments and then storing the divided erase commands in the command queues.

The operating method may further include: managing a fourth predetermined order of dies in which the greatest number of pages to the smallest number of pages are programmed among the dies, and wherein the distributing and storing of the divided erase commands includes distributing the divided erase commands in parallel between the “M” program commands so as to correspond to the fourth predetermined order and the “N” moments and then storing the divided erase commands in the command queues.

A first die among the dies may be coupled to a first channel, a second die among the dies may be coupled to a second channel, first planes included in the first die may be coupled to a plurality of first ways sharing the first channel with each other, and second planes included in the second die may be coupled to a plurality of second ways sharing the second channel with each other.

The predetermined condition may include grouping a first block included in a first plane among the first planes of the first die and a second block included in a second plane among the first planes of the first die and grouping a third block included in a third plane among the second planes of the second die and a fourth block included in a fourth plane among the second planes of the second die in the predetermined condition.

The predetermined condition may include grouping a first block included in a first plane among the first planes of the first die and a second block included in a second plane among the second planes of the second die and grouping a third block included in a third plane among the first planes of the first die and a fourth block included in a fourth plane among the second planes of the second die in the predetermined condition.

The predetermined condition may include grouping a first block included in a first plane among the first planes of the first die, a second block included in a second plane among the first planes of the first die, a third block included in a third plane among the second planes of the second die and a fourth block included in a fourth plane among the second planes of the second die in the predetermined condition.

A memory device may include a plurality of memory dies, each memory die having a plurality of memory blocks, wherein partial memory blocks in each memory die form first and second super memory blocks; and a controller suitable for controlling the memory device to perform erase operations to the second super memory block by units of the memory dies during the program operations to the first super memory block by units of pages in the respective memory dies, wherein the controller further may control the memory device to perform the erase operations to the respective memory dies in a time-distributed manner.

### BRIEF DESCRIPTION OF THE DRAWINGS

FIG. 1 is a block diagram illustrating a data processing system in accordance with an embodiment of the present invention.

FIG. 2 is a schematic diagram illustrating an exemplary configuration of a memory device employed in a memory system shown in FIG. 1.

FIG. 3 is a circuit diagram illustrating an exemplary configuration of a memory cell array of a memory block in a memory device shown in FIG. 1.

FIG. 4 is a block diagram illustrating a data processing system in accordance with an embodiment of the present invention.

FIG. 5 is a diagram schematically illustrating a data processing operation of a memory system to a memory device in accordance with an embodiment of the present invention.

FIG. 6 is a diagram illustrating a concept of a super memory block used in a memory system in accordance with an embodiment of the present invention.

FIGS. 7 and 8 are diagrams illustrating characteristic program and erase operations of a memory system in accordance with an embodiment of the present invention.

FIG. 9 is a diagram illustrating a method to manage information used by a controller of a memory system shown in FIGS. 7 and 8 to determine an order of erase operations of memory dies.

FIG. 10A to 10D are flowcharts illustrating operations of a memory system shown in FIGS. 7 and 8.

FIGS. 11 to 19 are diagrams schematically illustrating application examples of the data processing system, in accordance with various embodiments of the present invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate various features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the present invention will be described in detail with reference to the attached drawings.

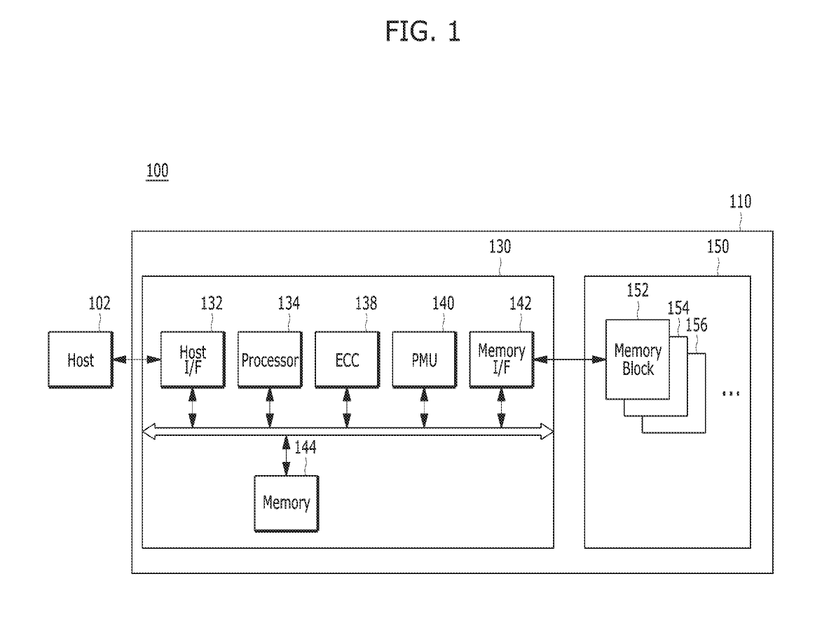

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include portable electronic devices such as a mobile phone, MP3 player and laptop computer or non-portable electronic devices such as a desktop computer, game machine, TV and projector.

The host 102 may include at least one OS (operating system), and the OS may manage and control overall functions and operations of the host 102, and provide an operation between the host 102 and a user using the data processing system 100 or the memory system 110. The OS may support functions and operations corresponding to the use purpose and usage of a user. For example, the OS may be divided into a general OS and a mobile OS, depending on the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a function of providing a mobile service to users and a power saving function of a system may include Android, iOS and Windows Mobile. At this time, the host 102 may include a plurality of OSs, and execute an OS to perform an operation corresponding to a user's request on the memory system 110.

The memory system 110 may operate to store data for the host 102 in response to a request of the host 102. Non-limited examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC, and the like. The SD card may include a mini-SD card and micro-SD card.

The memory system 110 may be embodied by various types of storage devices. Non-limited examples of storage devices included in the memory system 110 may include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory. The flash memory may have a 3-dimensioanl (3D) stack structure.

The memory system 110 may include a memory device 150 and a controller 130. The memory device 150 may store data for the host 102, and the controller 130 may control data storage into the memory device 150.

The controller 130 and the memory device 150 may be integrated into a single semiconductor device, which may be included in the various types of memory systems as exemplified above. For example, the controller 130 and the memory device 150 may be integrated as one semiconductor device to constitute an SSD. When the memory system 110 is used as an SSD, the operating speed of the host 102 connected to the memory system 110 can be improved. In addition, the controller 130 and the memory device 150 may be integrated as one semiconductor device to constitute a memory card. For example, the controller 130 and the memory device 150 may constitute a memory card such as a PCMCIA (personal computer memory card international association) card, CF card, SMC (smart media card), memory stick, MMC including RS-MMC and micro-MMC, SD card including mini-SD, micro-SD and SDHC, or UFS device.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory blocks 152 to 156, each of the memory blocks 152 to 156 may include a plurality of pages, and each of the pages may include a plurality of memory cells coupled to a word line. In an embodiment, the memory device 150 may be a flash memory. The flash memory may have a 3-dimensional (3D) stack structure.

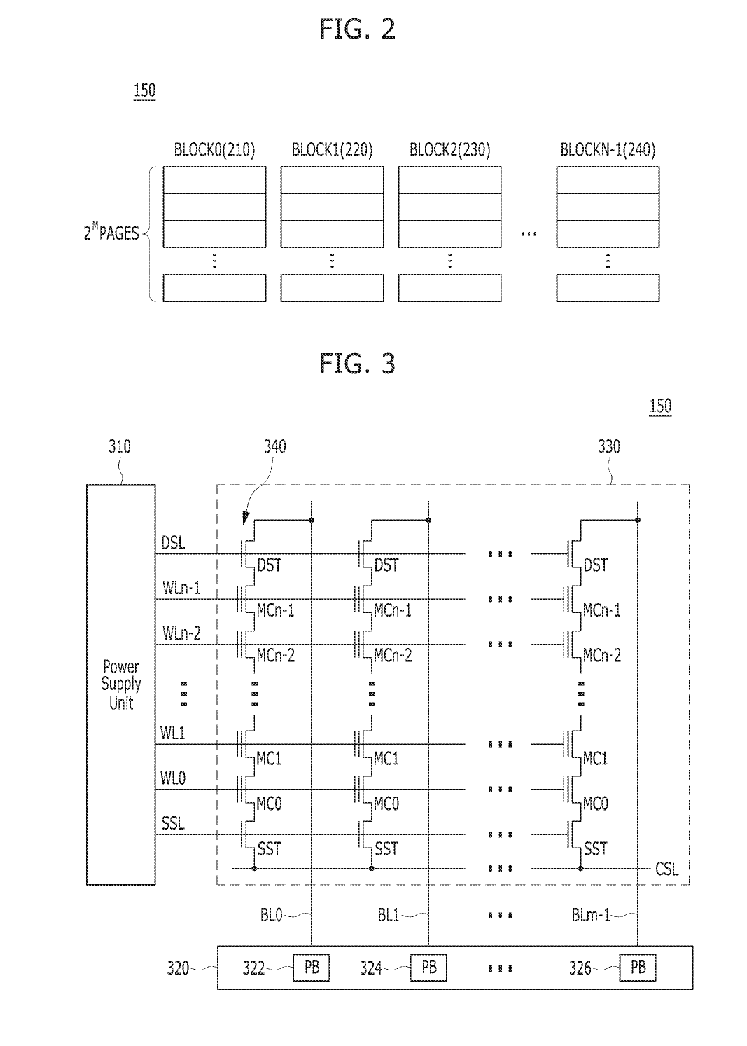

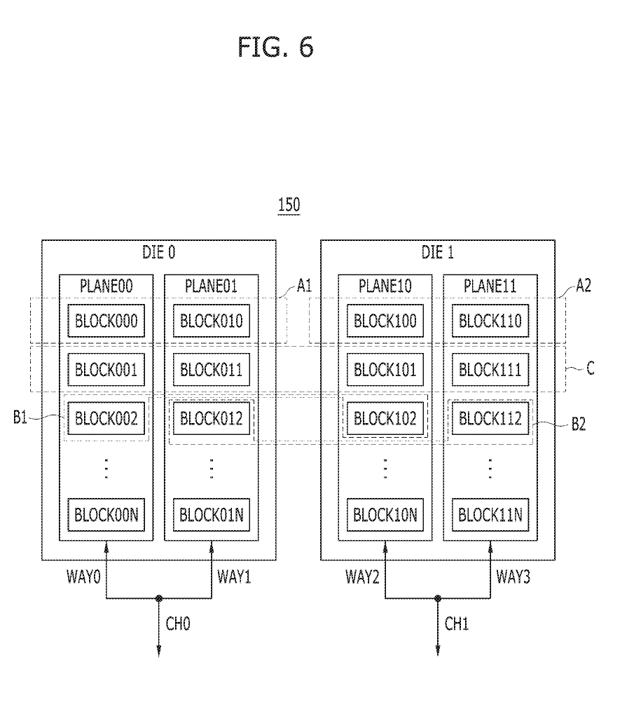

Herein, since the structure of the memory device 150 and the 3D stack structure of the memory device 150 will be described in detail later with reference to FIGS. 2 to 4 and the memory device 150 including a plurality of memory dies, the memory dies each of which includes a plurality of planes, and the planes each of which includes a plurality of memory blocks 152, 154 and 156 will be described in detail later with reference to FIG. 6, further description on them will be omitted herein.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) unit 132, a controller processor 134, an error correction code (ECC) unit 138, a Power Management Unit (PMU) 140, a NAND flash controller (NFC) 142 and a controller memory 144 all operatively coupled via an internal bus.

The host interface unit 134 may be configured to process a command and data of the host 102, and may communicate with the host 102 through one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE).

The ECC unit 138 may detect and correct an error contained in the data read from the memory device 150. In other words, the ECC unit 138 may perform an error correction decoding process to the data read from the memory device 150 through an ECC code used during an ECC encoding process. According to a result of the error correction decoding process, the ECC unit 138 may output a signal, for example, an error correction success/fail signal. When the number of error bits is more than a threshold value of correctable error bits, the ECC unit 138 may not correct the error bits, and may output an error correction fail signal.

The ECC unit 138 may perform error correction through a coded modulation such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC unit 138 is not limited thereto. The ECC unit 138 may include all circuits, modules, systems or devices for error correction.

The PMU 140 may provide and manage power of the controller 130.

The NFC 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the NFC 142 may generate a control signal for the memory device 150 and process data to be provided to the memory device 150 under the control of the controller processor 134. The NFC 142 may work as an interface (e.g., a NAND flash interface) for processing a command and data between the controller 130 and the memory device 150. Specifically, the NFC 142 may support data transfer between the controller 130 and the memory device 150.

The controller memory 144 may serve as a working memory of the memory system 110 and the controller 130, and store data for driving the memory system 110 and the controller 130. The controller 130 may control the memory device 150 to perform read, write, program and erase operations in response to a request from the host 102. The controller 130 may provide data read from the memory device 150 to the host 102, may store data provided from the host 102 into the memory device 150. The controller memory 144 may store data required for the controller 130 and the memory device 150 to perform these operations.

The controller memory 144 may be embodied by a volatile memory. For example, the controller memory 144 may be embodied by static random access memory (SRAM) or dynamic random access memory (DRAM). The controller memory 144 may be disposed within or out of the controller 130. FIG. 1 exemplifies the controller memory 144 disposed within the controller 130. In an embodiment, the controller memory 144 may be embodied by an external volatile memory having a memory interface transferring data between the controller memory 144 and the controller 130.

The controller processor 134 may control the overall operations of the memory system 110. The controller processor 134 may drive firmware to control the overall operations of the memory system 110. The firmware may be referred to as flash translation layer (FTL). Also, the controller processor 134 may be realized as a microprocessor or a Central Processing Unit (CPU).

For example, the controller 130 may perform an operation requested by the host 102 in the memory device 150 through the controller processor 134, which is realized as a microprocessor or a CPU. In other words, the controller 130 may perform a command operation corresponding to a command received from the host 102. Herein, the controller 130 may perform a foreground operation as the command operation corresponding to the command received from the host 102. For example, the controller 130 may perform a program operation corresponding to a write command, a read operation corresponding to a read command, an erase operation corresponding to an erase command, and a parameter set operation corresponding to a set parameter command or a set feature command as a set command.

Also, the controller 130 may perform a background operation onto the memory device 150 through the controller processor 134, which is realized as a microprocessor or a CPU. Herein, the background operation performed onto the memory device 150 may include an operation of copying and processing data stored in some memory blocks among the memory blocks 152, 154 and 156 of the memory device 150 into other memory blocks, e.g., a garbage collection (GC) operation, an operation of performing swapping between the memory blocks 152, 154 and 156 of the memory device 150 or between the data of the memory blocks 152, 154 and 156, e.g., a wear-leveling (WL) operation, an operation of storing the map data stored in the controller 130 in the memory blocks 152, 154 and 156 of the memory device 150, e.g., a map flush operation, or an operation of managing bad blocks of the memory device 150, e.g., a bad block management operation of detecting and processing bad blocks among the memory blocks 152, 154 and 156 included in the memory device 150.

Also, in the memory system in accordance with the embodiment of the present invention, for example, the controller 130 may perform a plurality of command operations corresponding to a plurality of commands received from the host 102, e.g., a plurality of program operations corresponding to a plurality of write commands, a plurality of read operations corresponding to a plurality of read commands, and a plurality of erase operations corresponding to a plurality of erase commands, in the memory device 150, and update metadata, particularly, map data, according to the performance of the command operations.

In particular, in the memory system in accordance with the embodiment of the present invention, when the controller 130 performs command operations corresponding to a plurality of commands received from the host 102, e.g., program operations, read operations, and erase operations, in the memory blocks included in the memory device 150, the operation reliability of the memory device 150 may be deteriorated and also the utility efficiency of the memory device 150 may decrease because characteristics are deteriorated in the memory blocks due to the performance of the command operations. Therefore, a copy operation or a swap operation may be performed in the memory device 150 in consideration of the parameters for the memory device 150 according to the performance of the command operations.

For example, in the memory system in accordance with the embodiment of the present invention, when the controller 130 performs program operations corresponding to a plurality of write commands received from the host 102 in the memory blocks included in the memory device 150, the controller 130 may perform a copy operation, e.g., a garbage collection operation, onto the memory device 150 in order to improve the utility efficiency of the memory device 150 included in the memory system 110.

Also, in the memory system in accordance with the embodiment of the present invention, when the controller 130 performs erase operations corresponding to a plurality of erase commands received from the host 102 in the memory blocks included in the memory device 150, each of the memory blocks included in the memory device 150 may have a limited erase count, and accordingly, the controller 130 may perform erase operations corresponding to the erase commands within the range of the limited erase count. For example, when the controller 130 performs erase operations onto particular memory blocks while exceeding the limited erase count, the particular memory blocks may be processed as bad blocks, which may not be used any more. Herein, the limited erase count for the memory blocks of the memory device 150 may represent the maximal count that erase operations may be performed onto the memory blocks of the memory device 150. Therefore, in the memory system in accordance with the embodiment of the present invention, erase operations may be performed uniformly within the range of the limited erase count for the memory blocks of the memory device 150. Also, in order to secure operation reliability for the memory blocks of the memory device 150 from the erase operations, data may be processed with the memory blocks of the memory device 150 in consideration of the parameters of the memory blocks of the memory device 150, for example, a swap operation, e.g., a wear-leveling operation, may be performed in the memory device 150.

Also, in the memory system in accordance with the embodiment of the present invention, when the controller 130 performs read operations corresponding to a plurality of read commands received from the host 102 in the memory blocks included in the memory device 150, particularly, when the controller 130 repeatedly performs read operations in some particular memory blocks, read disturbance may be caused in the particular memory blocks due to the repeated read operations. Therefore, the controller 130 may perform a read reclaim operation to protect the particular memory blocks from losing data due to the read disturbance. In other words, in the memory system in accordance with the embodiment of the present invention, the controller 130 may copy and store the data stored in the particular memory blocks into other memory blocks through the read reclaim operation. In short, the controller 130 may perform a copy operation for the particular memory blocks in the memory device 150.

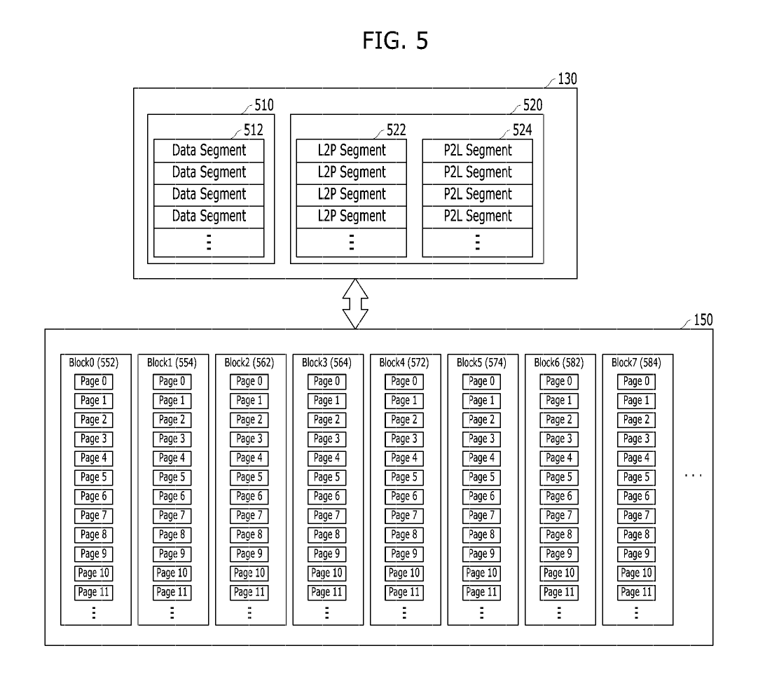

Herein, in the memory system in accordance with the embodiment of the present invention, the controller 130 may perform not only a swap operation and a copy operation but also a bad block management operation for some memory blocks in consideration of the parameters according to the performance of command operations corresponding to the commands received from the host 102, e.g., valid page counts (VPC) of the memory blocks of the memory device 150 according to the performance of program operations, erase counts according to the performance of erase operations, program counts according to the performance of program operations, and read counts according to the performance of read operations. Also, in the memory system in accordance with the embodiment of the present invention, the controller 130 may perform a copy operation, e.g., a garbage collection operation, onto the memory blocks of the memory device 150 in consideration of the parameters corresponding to not only the swap operation and the copy operation but also the bad block management operation that are performed in the memory blocks of the memory device 150. Herein, in the memory system in accordance with the embodiment of the present invention, since the performance of the command operations corresponding to a plurality of commands received from the host 102 and the performance of the swap operation and the copy operation performed in the memory device 150 in consideration of the parameters corresponding to the performance of the command operations will be described in detail later with reference to FIGS. 5 to 9, further description on it will be omitted herein.

The processor 134 of the controller 130 may include a management unit (not illustrated) for performing a bad management operation of the memory device 150. The management unit may perform a bad block management operation of checking a bad block, in which a program fail occurs due to a characteristic of the memory device, for example, a NAND flash memory during a program operation, among the plurality of memory blocks 152 to 156 included in the memory device 150. The management unit may write the program-failed data of the bad block to a new memory block. In a memory device 150 having a 3D stack structure, the bad block management operation may reduce the use efficiency of the memory device 150 and the reliability of the memory system 110. Thus, the bad block management operation needs to be performed with more reliability. Hereafter, the memory device of the memory system in accordance with the embodiment of the present invention is described in detail with reference to FIGS. 2 to 4.

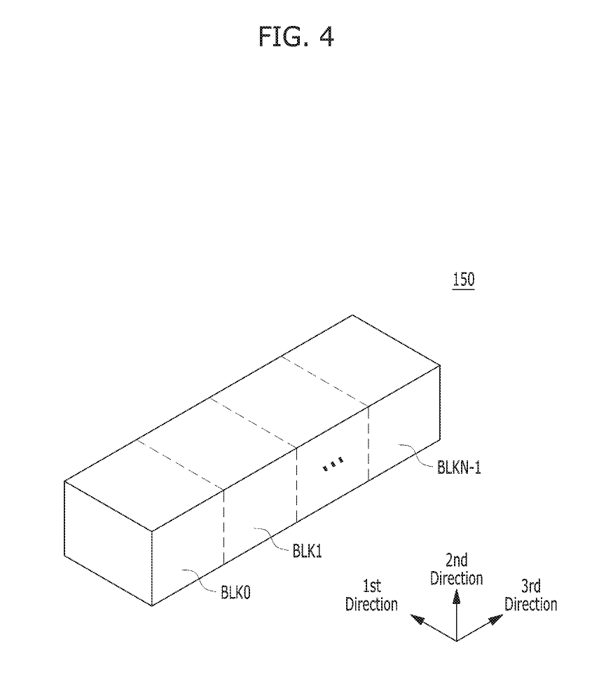

FIG. 2 is a schematic diagram illustrating the memory device 150, FIG. 3 is a circuit diagram illustrating an exemplary configuration of a memory cell array of a memory block in the memory device 150 and FIG. 4 is a schematic diagram illustrating an exemplary 3D structure of the memory device 150.

Referring to FIG. 2, the memory device 150 may include a plurality of memory blocks 0 to N-1, e.g., a memory block 0 BLK0 210, a memory block 1 BLK1 220, a memory block 2 BLK2 230, and a memory block N-1 BLKN-1 240, and each of the memory blocks 210, 220, 230 and 240 may include a plurality of pages, for example, 2^{M} pages, the number of which may vary according to circuit design. Herein, although it is described that each of the memory blocks include 2^{M} pages, each of the memory blocks may include M pages as well. Each of the pages may include a plurality of memory cells that are coupled to a plurality of word lines WL.

Also, the memory device 150 may include a plurality of memory blocks, which may include a single level cell (SLC) memory block storing 1-bit data and/or a multi-level cell (MLC) memory block storing 2-bit data. Herein, the SLC memory blocks may include a plurality of pages that are realized by memory cells storing one-bit data in one memory cell. The SLC memory blocks may have a quick data operation performance and high durability. On the other hand, the MLC memory blocks may include a plurality of pages that are realized by memory cells storing multi-bit data, e.g., data of two or more bits, in one memory cell. The MLC memory blocks may have a greater data storing space than the SLC memory blocks. In other words, the MLC memory blocks may be highly integrated. Particularly, the memory device 150 may include not only the MLC memory blocks each of which includes a plurality of pages that are realized by memory cells capable of storing two-bit data in one memory cell, but also triple level cell (TLC) memory blocks each of which includes a plurality of pages that are realized by memory cells capable of storing three-bit data in one memory cell, quadruple level cell (QLC) memory blocks each of which includes a plurality of pages that are realized by memory cells capable of storing four-bit data in one memory cell, and/or multiple level cell memory blocks each of which includes a plurality of pages that are realized by memory cells capable of storing five or more-bit data in one memory cell, and so forth.

Herein, in accordance with the embodiment of the present invention, although it is described that the memory device 150 is a non-volatile memory, such as a flash memory, e.g., a NAND flash memory, the memory device 150 may be realized as one memory among a Phase Change Random Access Memory (PCRAM), a Resistive Random Access Memory (RRAM or ReRAM), a Ferroelectric Random Access Memory (FRAM), a Spin Transfer Torque Magnetic Random Access Memory (STT-RAM or STT-MRAM).

The memory blocks 210, 220, 230 and 240 may store the data transferred from the host 102 through a program operation, and transfer data stored therein to the host 102 through a read operation.

Subsequently, referring to FIG. 3, a memory block 330 which may correspond to any of the plurality of memory blocks 152 to 156 included in the memory device 150 of the memory system 110 may include a plurality of cell strings 340 coupled to a plurality of corresponding bit lines BL0 to BLm−1. The cell string 340 of each column may include one or more drain select transistors DST and one or more source select transistors SST. Between the drain and select transistors DST and SST, a plurality of memory cells MC0 to MCn−1 may be coupled in series. In an embodiment, each of the memory cell transistors MCO to MCn−1 may be embodied by an MLC capable of storing data information of a plurality of bits. Each of the cell strings 340 may be electrically coupled to a corresponding bit line among the plurality of bit lines BLO to BLm−1. For example, as illustrated in FIG. 3, the first cell string is coupled to the first bit line BLO, and the last cell string is coupled to the last bit line BLm-1.

Although FIG. 3 illustrates NAND flash memory cells, the invention is not limited in this way. It is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage and a pass voltage to supply to the word lines according to an operation mode. The voltage generation operation of the voltage supply unit 310 may be controlled by a control circuit (not illustrated). Under the control of the control circuit, the voltage supply unit 310 may select one of the memory blocks (or sectors) of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

The memory device 150 may be embodied by a 2D or 3D memory device. Particularly, as illustrated in FIG. 4, the memory device 150 may be embodied by a nonvolatile memory device having a 3D stack structure. When the memory device 150 has a 3D structure, the memory device 150 may include a plurality of memory blocks BLKO to BLKN-1. Herein, FIG. 4 is a block diagram illustrating the memory blocks 152, 154 and 156 of the memory device 150 shown in FIG. 1. Each of the memory blocks 152, 154 and 156 may be realized in a 3D structure (or vertical structure). For example, the memory blocks 152, 154 and 156 may include structures of a three-dimensional structure that are extended in first to third directions, e.g., an x-axis direction, a y-axis direction, and a z-axis direction.

Each memory block 330 included in the memory device 150 may include a plurality of NAND strings NS that are extended in the second direction, and a plurality of NAND strings NS that are extended in the first direction and the third direction. Herein, each of the NAND strings NS may be coupled to a bit line BL, at least one string selection line SSL, at least one ground selection line GSL, a plurality of word lines WL, at least one dummy word line DWL, and a common source line CSL, and each of the NAND strings NS may include a plurality of transistor structures TS.

In short, each memory block 330 among the memory blocks 152, 154 and 156 of the memory device 150 may be coupled to a plurality of bit lines BL, a plurality of string selection lines SSL, a plurality of ground selection lines GSL, a plurality of word lines WL, a plurality of dummy word lines DWL, and a plurality of common source lines CSL, and each memory block 330 may include a plurality of NAND strings NS. Also, in each memory block 330, one bit line BL may be coupled to a plurality of NAND strings NS to realize a plurality of transistors in one NAND string NS. Also, a string selection transistor SST of each NAND string NS may be coupled to a corresponding bit line BL, and a ground selection transistor GST of each NAND string NS may be coupled to a common source line CSL. Herein, memory cells MC may be provided between the string selection transistor SST and the ground selection transistor GST of each NAND string NS. In other words, a plurality of memory cells may be realized in each memory block 330 of the memory blocks 152, 154 and 156 of the memory device 150. Hereafter, a data processing operation toward a memory device, particularly, a data processing operation performed when a plurality of command operations corresponding to a plurality of commands received from the host 102 are performed, in a memory system in accordance with an embodiment of the present invention is described in detail with reference to FIGS. 5 to 9.

FIG. 5 is a diagram schematically illustrating a data processing operation of a memory system to a memory device in accordance with an embodiment of the present invention.

Referring to FIG. 5, the controller 130 may perform a command operation corresponding to a command received from the host 102. For example, the controller 130 may perform a program operation corresponding to a program command. The controller 130 may program and store user data corresponding to the program command in a plurality of pages included in memory blocks 552, 554, 562, 564, 572, 574, 582 and 584 of the memory device 150.

After generating and updating meta data for the user data, the controller 130 may program and store the meta data in the memory blocks 552, 554, 562, 564, 572, 574, 582 and 584. The meta data may include Logical to Physical (L2P) information and Physical to Logical (P2L) information on the user data stored in the memory blocks 552, 554, 562, 564, 572, 574, 582 and 584. In addition, the meta data may include information on command data corresponding to the command received from the host 102, information on the command operation corresponding to the command, information on the memory blocks of the memory device 150 on which the command operation is performed, information on map data corresponding to the command operation, and the like. In other words, the meta data may include all information and data except the user data corresponding to the command received from the host 102.

For example, the controller 130 may cache and buffer the user data corresponding to the program command received from the host 102 in a first buffer 510 included in the memory 144 of the controller 130. In other words, the controller 130 may store data segments 512 of the user data in the first buffer 510 which is a data buffer/cache. Henceforth, the controller 130 may program and store the data segments 512 stored in the first buffer 510 in the pages included in the memory blocks 552, 554, 562, 564, 572, 574, 582 and 584 of the memory device 150.

As the data segments 512 of the user data are programmed and stored in the pages included in the memory blocks 552, 554, 562, 564, 572, 574, 582 and 584 of the memory device 150, the controller 130 may generate L2P segments 522 and P2L segments 524 which are the meta data and may subsequently store the L2P segments 522 and P2L segments 524 in a second buffer 520 included in the memory 144 of the controller 130. The L2P segments 522 and P2L segments 524 may be stored in a list in the second buffer 520. Henceforth, the controller 130 may program and store the L2P segments 522 and P2L segments 524 stored in the second buffer 520 in the pages included in the memory blocks 552, 554, 562, 564, 572, 574, 582 and 584 of the memory device 150 through a map flush operation.

Furthermore, the controller 130 may perform the command operation corresponding to the command received from the host 102. For example, the controller 130 may perform a read operation corresponding to a read command. The controller 130 may load the L2P segments 522 and P2L segments 524 of the user data corresponding to the read command into the second buffer 520 to verify storage locations, i.e., the memory blocks 552, 554, 562, 564, 572, 574, 582 and 584. The controller 130 may read the data segments 512 of the user data from a specific page of a specific memory block among the memory blocks 552, 554, 562, 564, 572, 574, 582 and 584 and may store the data segments 512 in the first buffer 510. Subsequently, the data segments 512 stored in the first buffer 510 may be supplied to the host 102.

FIG. 6 is a diagram illustrating a concept of a super memory block used in a memory system in accordance with an embodiment of the present invention.

FIG. 6 illustrates in detail constituent elements of the memory device 150 among the constituent element of the memory system 110 shown in FIG. 1 in accordance with an embodiment of the present invention.

The memory device 150 may include a plurality of memory blocks BLOCK000 to BLOCK00N, BLOCK010 to BLOCK01N, BLOCK100 to BLOCK1ON and BLOCK110 to BLOCK11N.

In addition, the memory device 150 may include a first memory die DIE0 capable of inputting/outputting data through a zeroth channel

CH0 and a second memory die DIE1 capable of inputting/outputting data through a first channel CH1. The zeroth and first channels CH0 and CH1 may input/output data in an interleaving scheme.

The first memory die DIE0 may include a plurality of planes PLANE00 and PLANE01 respectively corresponding to a plurality of ways WAY0 and WAY1. The ways WAY0 and WAY1 may input/output data in the interleaving scheme by sharing the zeroth channel CH0.

The second memory die DIE1 may include a plurality of planes PLANE 10 and PLANE 11 respectively corresponding to a plurality of ways WAY2 and WAY3. The ways WAY2 and WAY3 may input/output data in the interleaving scheme by sharing the first channel CH1.

The first plane PLANE00 of the first memory die DIE0 may include a predetermined number of memory blocks BLOCK000 to BLOCK00N among the plurality of memory blocks BLOCK000 to BLOCK00N, BLOCK010 to BLOCK01N, BLOCK100 to BLOCK10N and BLOCK110 to BLOCK11N.

The second plane PLANE01 of the first memory die DIE0 may include a predetermined number of memory blocks BLOCK010 to BLOCK01N among the plurality of memory blocks BLOCK000 to BLOCK00N, BLOCK010 to BLOCK01N, BLOCK100 to BLOCK10N and BLOCK110 to BLOCK11N.

The first plane PLANE10 of the second memory die DIE1 may include a predetermined number of memory blocks BLOCK100 to BLOCK10N among the plurality of memory blocks BLOCK000 to BLOCK00N, BLOCK010 to BLOCK01N, BLOCK100 to BLOCK10N and BLOCK110 to BLOCK11N.

The second plane PLANE11 of the second memory die DIE1 may include a predetermined number of memory blocks BLOCK110 to BLOCK11N among the plurality of memory blocks BLOCK000 to BLOCK00N, BLOCK010 to BLOCK01N, BLOCK100 to BLOCK10N and BLOCK110 to BLOCK11N.

In this manner, the plurality of memory blocks BLOCK000 to BLOCK00N, BLOCK010 to BLOCK01N, BLOCK100 to BLOCK10N and BLOCK110 to BLOCK11N included in the memory device 150 may be divided into groups, according to their physical locations and their use of the ways and channels.

Although it is described in the embodiment of the present invention that two memory dies DIE0 and DIE1 are included in the memory device 150, two planes PLANE00 and PLANE01/PLANE10 and PLANE11 are included in the respective memory dies DIE0 and DIE1, and the predetermined number of memory blocks BLOCK000 to BLOCK00N, BLOCK010 to BLOCK01N, BLOCK100 to BLOCK10N and BLOCK110 to BLOCK11N are included in the respective planes PLANE00 and PLANE01/PLANE10 and PLANE11, the invention is not limited in this way. In actuality, more or fewer memory dies than two may be included in the memory device 150, more or fewer planes than two may be included in the respective memory dies, according to the decision of a system designer. Besides, the predetermined number of memory blocks included in the respective planes may be also adjusted variously according to the decision of the system designer.

Differently from such a way to divide the plurality of memory blocks BLOCK000 to BLOCK00N, BLOCK010 to BLOCK01N, BLOCK100 to BLOCK10N and BLOCK110 to BLOCK11N included in the memory device 150 depending on their physical locations such as the memory dies DIE0 and DIE1 or the planes PLANE00 and PLANE01/PLANE10 and PLANE11, the controller 130 may use a way to divide the plurality of memory blocks BLOCK000 to BLOCK00N, BLOCK010 to BLOCK01N, BLOCK100 to BLOCK10N and BLOCK110 to BLOCK11N on a basis of memory blocks which are simultaneously selected and operate thereamong. In other words, the controller 130 may manage a plurality of memory blocks which are located in different dies or different planes based on their physical locations, by grouping memory blocks capable of being selected simultaneously among the plurality of memory blocks and thereby dividing the grouped memory blocks into super memory blocks.

The simultaneous selection scheme of grouping the memory blocks into super memory blocks by the controller 130 may be performed in various manners according to the decision of the system designer. Herein, three simultaneous selection schemes will be exemplified as follows.

A first scheme is to group an arbitrary memory block BLOCK000 from the first plane PLANE00 and an arbitrary memory block BLOCK010 from the second plane PLANE01 of the first memory die DIE0 between the memory dies DIE0 and DIE1 included in the memory device 150 and manage the grouped memory blocks BLOCK000 and BLOCK010 as a single super memory block A1. When the first way is applied to the second memory die DIE1 between the memory dies DIE0 and DIE1 included in the memory device 150, the controller 130 may group an arbitrary memory block BLOCK100 from the first plane PLANE10 and an arbitrary memory block BLOCK110 from the second plane PLANE11 of the second memory die DIE1 and manage the grouped memory blocks BLOCK100 and BLOCK110 as a single super memory block A2.

A second scheme is to group an arbitrary memory block BLOCK002 from the first plane PLANE00 of the first memory die DIE0 and an arbitrary memory block BLOCK102 from the first plane PLANE10 of the second memory die DIE1 and manage the grouped memory blocks BLOCK002 and BLOCK102 as a single super memory block B1. In addition, according to the second way, the controller 130 may group an arbitrary memory block BLOCK012 from the second plane PLANE01 of the first memory die DIE0 and an arbitrary memory block BLOCK112 from the second plane PLANE11 of the second memory die DIE1 and manage the grouped memory blocks BLOCK012 and BLOCK112 as a single super memory block B2.

A third scheme is to group an arbitrary memory block BLOCK001 from the first plane PLANE00 of the first memory die DIE0, an arbitrary memory block BLOCK011 from the second plane PLANE01 of the first memory die DIED, an arbitrary memory block BLOCK101 from the first plane PLANE10 of the second memory die DIE1, and an arbitrary memory block BLOCK111 from the second plane PLANE11 of the second memory die DIE1 and manage the grouped memory blocks BLOCK001, BLOCK011, BLOCK101 and BLOCK111 as a single super memory block C.

The simultaneously-selectable memory blocks included in the respective super memory blocks may be substantially simultaneously selected by the controller 130 through an interleaving scheme, for example, a channel interleaving scheme, a memory die interleaving scheme, a memory chip interleaving scheme or a way interleaving scheme.

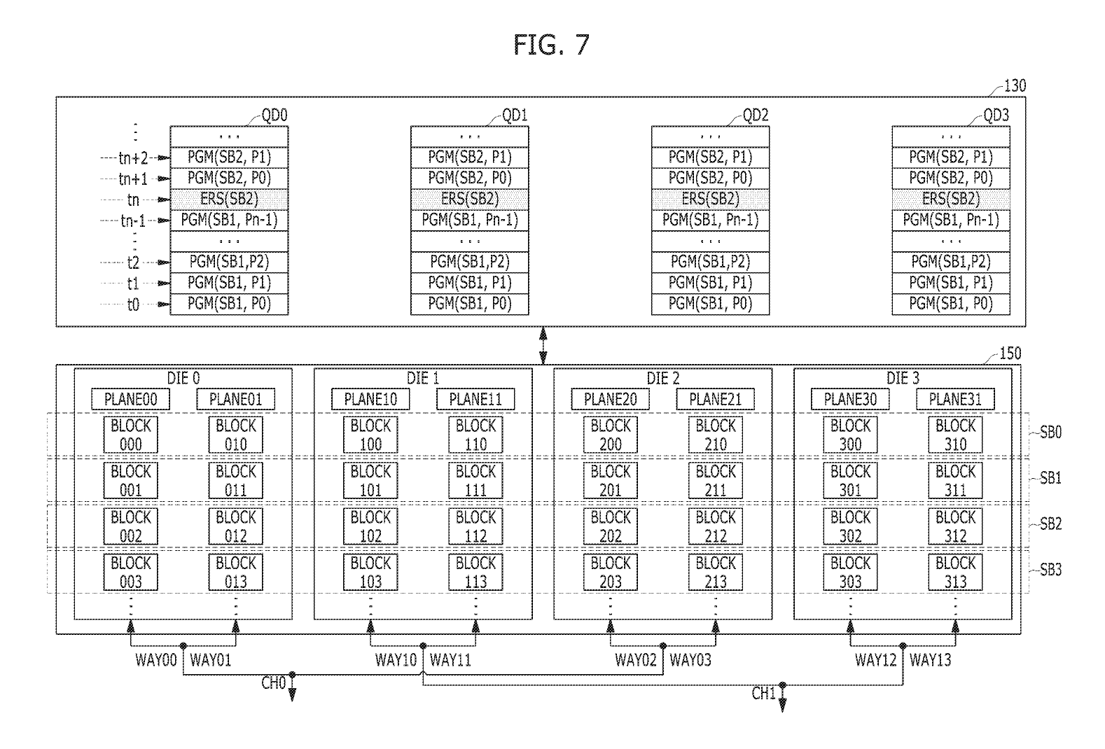

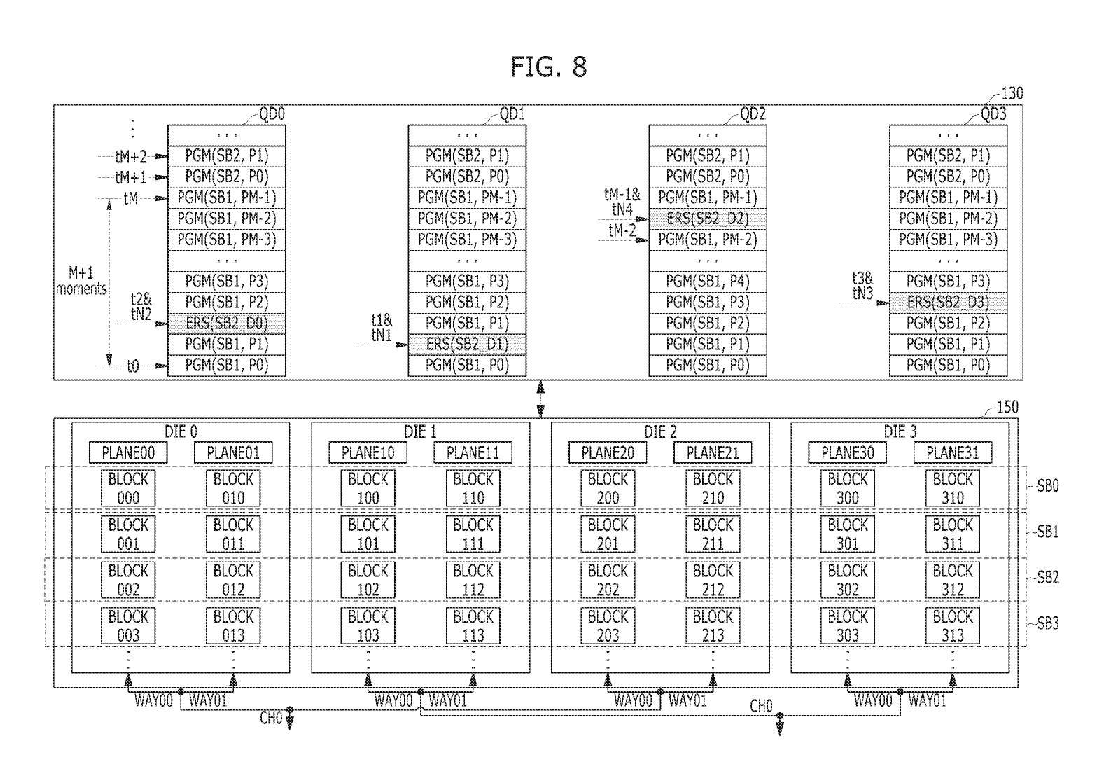

FIGS. 7 and 8 are diagrams illustrating characteristic program and erase operations of the memory system 110 in accordance with an embodiment of the present invention.

Referring to FIGS. 7 and 8, when the controller 130 manages a plurality of memory blocks included in the memory device 150 by dividing the memory blocks into a plurality of super memory blocks, a scheme of selecting the plurality of super memory blocks may be seen.

The memory device 150 may include a plurality of memory blocks BLOCK<000:003 . . . , 010:013 . . . , 100:103 . . . , 110:113 . . . , 200:203 . . . , 210:213 . . . , 300:303 . . . , 310:313 . . . > including a plurality of pages, a plurality of planes PLANE<00:01, 10:11, 20:21, 30:31>including the plurality of memory blocks BLOCK<000:003 . . . , 010:013 . . . , 100:103 . . . , 110:113 . . . , 200:203 . . . , 210:213 . . . , 300:303 . . . , 310:313 . . . >, and a plurality of dies DIE<0:3> including the plurality of planes PLANE<00:01, 10:11, 20:21, 30:31>.

As shown in the drawings, the memory device 150 may include four memory dies DIE<0:3>, and the four memory dies DIE<0:3> may include two planes PLANE<00:01>, PLANE<10:11>, PLANE<20:21>and PLANE<30:31> respectively. The planes PLANE<00:01, 10:11, 20:21, 30:31> may include the memory blocks BLOCK<000:003 . . . , 010:013 . . . , 100:103 . . . , 110:113 . . . , 200:203 . . . . , 210:213 . . . , 300:303 . . . , 310:313 . . .> respectively. Although it is not illustrated in drawings, each of the memory blocks BLOCK<000:003 . . . , 010:013_, 100:103 . . . , 110:113 . . . , 200:203 . . . , 210:213 . . . , 300:303 . . . , 310:313 . . . > may include the plurality of pages, for example, 2AM pages, as shown in FIGS. 2 and 5.

Also, it is exemplified that, in the memory device 150, the total eight planes PLANE<00:01, 10:11, 20:21, 30:31> included in the four memory dies DIE<0:3> input/output data through two channels CH<0:1> and eight ways WAY<00:03, 10:13>.

Namely, it is exemplified that, in the memory device 150, that the four planes PLANE<00:01, 20:21> or PLANE<10:11, 30:31>corresponding to the four ways WAY<00:03> or WAY<10:13> share one of the two channels CH<0:1>. Specifically, the zeroth memory die DIE0 and the second memory die DIE2 may share the zeroth channel CH0, and the first memory die DIE1 and the third memory die DIE3 may share the first channel CH1. Also, the four planes PLANE<00:01, 20:21> respectively included in the zeroth memory die DIE0 and the second memory die DIE2 may be coupled to the zeroth channel CHO through the four ways WAY<00:03>. The four planes PLANE<10:11, 30:31> respectively included in the first memory die DIE1 and the third memory die DIE3 may be coupled to the first channel CH1 through the four ways WAY<10:13>.

The controller 130 may include a plurality of command queues QD<0:3> for controlling command operations on each of the memory dies DIE<0:3>. The command operations on each of the memory dies DIE<0:3> may include, for example, program/read/erase operations, which are performed through the memory device 150 by the control of the controller 130. In other words, the controller 130 may queue an operation to be performed on each of the memory dies DIE<0:3> in the command queues QD<0:3> in sequence according to a predetermined scheme and thereby controlling the operation to be performed on each of the memory dies DIE<0:3>.

The controller 130 may manage the plurality of memory blocks BLOCK<000:003 . . . , 010:013 . . . , 100:103 . . . , 110:113 . . . , 200:203 . . . , 210:213 . . . , 300:303 . . . , 310:313 . . . > in units of super memory blocks, by grouping them in a type corresponding to a predetermined condition. The predetermined condition may indicate the scheme of managing, by the controller 130, the memory blocks BLOCK<000:003 . . . , 010:013 . . . , 100:103 . . . , 110:113 . . . , 200:203 . . . , 210:213 . . . , 300:303 . . . , 310:313 . . . > by dividing them into the super memory blocks, as described earlier with reference to FIG. 6. The controller 130 in accordance with an embodiment of the present invention shown in FIGS. 7 and 8 uses the third scheme among the three simultaneous selection schemes of dividing the memory blocks into the super memory blocks. That is to say, the controller 130 shown in FIGS. 7 and 8 may select an arbitrary memory block from each of the eight planes PLANE<00:01, 10:11, 20:21, 30:31> included in the memory device 150 and manage the selected memory blocks as a single super memory block SB0, SB1, SB2, SB3 . . . . However, it should be understood that the scheme described above with reference to FIGS. 7 and 8 is merely an example, it is possible to manage super memory blocks in different schemes according to the decision of the system designer.

The scheme of managing, by the controller 130, the memory blocks BLOCK<000:003 . . . , 010:013 . . . , 100:103 . . . , 110:113 . . . , 200:203 . . . , 210:213 . . . , 300:303 . . . , 310:313 . . . > included in the memory device 150 by dividing them into the super memory blocks SB<0:3 . . . > may indicate that the controller 130 processes in units of super memory blocks when an access operation, i.e., the read/program/erase operations, of the memory device 150 is performed.

For example, when the controller 130 accesses the zeroth super memory block SB0, it may mean that the controller 130 accesses in parallel the zeroth memory blocks BLOCK<000, 010, 100, 110, 200, 210, 300, 310> grouped into the zeroth super memory block SB0. When the controller 130 accesses the first super memory block SB1, it may mean that the controller 130 accesses in parallel the first memory blocks BLOCK<001, 011, 101, 111, 201, 211, 301, 311> grouped into the first super memory block SB1. When the controller 130 accesses the second super memory block SB2, it may mean that the controller 130 accesses in parallel the second memory blocks BLOCK<002, 012, 102, 112, 202, 212, 302, 312> grouped into the second super memory block SB2. When the controller 130 accesses the third super memory block SB3, it may mean that the controller 130 accesses in parallel the third memory blocks BLOCK<003, 013, 103, 113, 203, 213, 303, 313> grouped into the third super memory block SB3 .

Accordingly, the controller 130 may generate read/program/erase commands so that the read/program/erase operations may be performed in units of the super memory blocks. Detailed descriptions thereon are provided hereinafter.

Referring to FIG. 7, the controller 130 may generate “n” program commands PGM (SB1, P<O:n−1>) and queue the commands in parallel in the command queues QD<O:3> in order to perform the program operation on “n” pages P<0:n−1> included in the first memory blocks BLOCK<001, 011, 101, 111, 201, 211, 301, 311> grouped into the first super memory block SB1.

In other words, the controller 130 may queue a first program command PGM (SB1, P0) among the “n” program commands PGM (SB1,

P<0:n−1>) in parallel in the command queues QD<0:3> at a t0 moment. Subsequently, the controller 130 may queue a second program command PGM (SB1, P1) among the “n” program commands PGM (SB1, P<O:n−1>) in parallel in the command queues QD<0:3> at a t1 moment. Subsequently, the controller 130 may queue a third program command PGM (SB1, P2) among the “n” program commands PGM (SB1, P<0:n−1>) in parallel in the command queues QD<0:3> at a t2 moment. In this manner, the controller 130 may queue an n^{th} program command PGM (SB1, Pn−1) among the “n” program commands PGM (SB1, P<0:n−1>) in parallel in the command queues QD<0:3> at a tn−1 moment.

Similarly, the controller 130 may queue an erase command ERS (SB2) in parallel in the command queues QD<0:3> at a to moment in order to perform the erase operation on the second memory blocks BLOCK<002, 012, 102, 112, 202, 212, 302, 312> grouped into the second super memory block SB2, Also, the controller 130 may generate program commands PGM (SB2, P<0,1, . . . >) and queue the program commands PGM (S32, P<0,1, . . . >) in parallel in the command queues QD<0:3> from a tn+1 moment in order to perform the program operation on the second memory blocks BLOCK<002, 012, 102, 112, 202, 212, 302, 312> grouped into the second super memory block SB2.

As described above, the controller 130 may operate the memory dies DIE<0:3> grouped in units of the super memory blocks SB<0:3 . . . > in parallel by generating the commands for performing the program/read/erase operations on the memory blocks BLOCK<001, 011, 101, 111, 201, 211, 301, 311/002, 012, 102, 112, 202, 212, 302, 312/003, 013, 103, 113, 203, 213, 303, 313 . . . > grouped into the super memory blocks SB<0:3 . . .> and storing the commands in parallel in the command queues QD<0:3>. In other words, the controller 130 may control the memory blocks BLOCK<001, 011, 101, 111, 201, 211, 301, 311/002, 012, 102, 112, 202, 212, 302, 312/003, 013, 103, 113, 203, 213, 303, 313/ . . . > grouped in units of the super memory blocks SB<0:3 . . . > to perform the same command operation in parallel at the same moment.

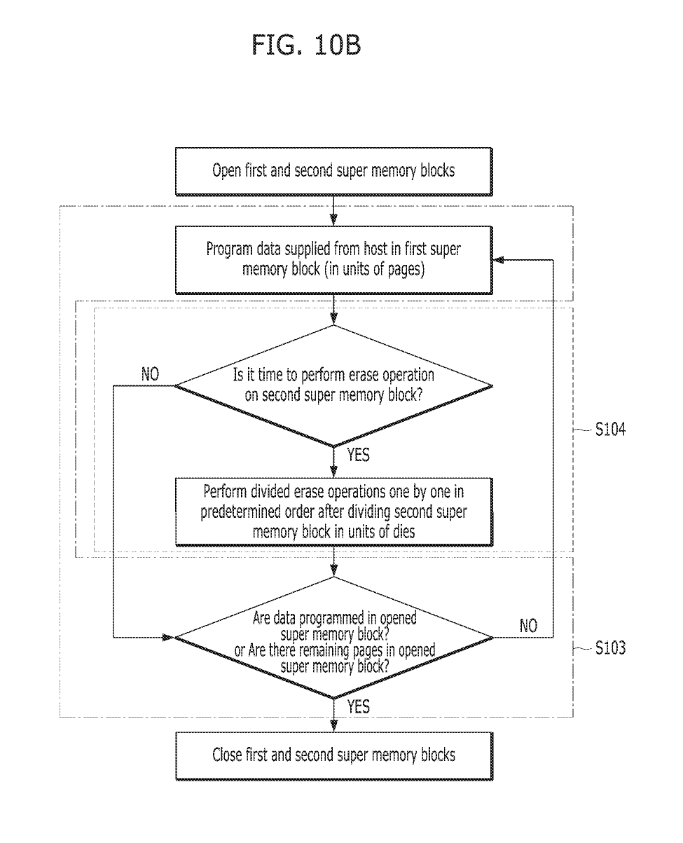

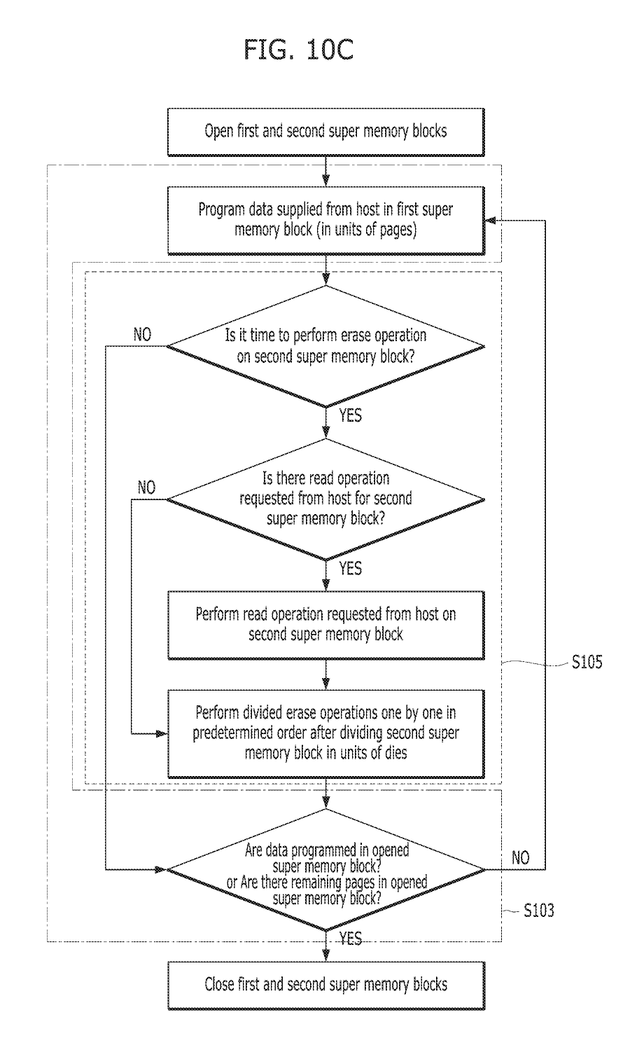

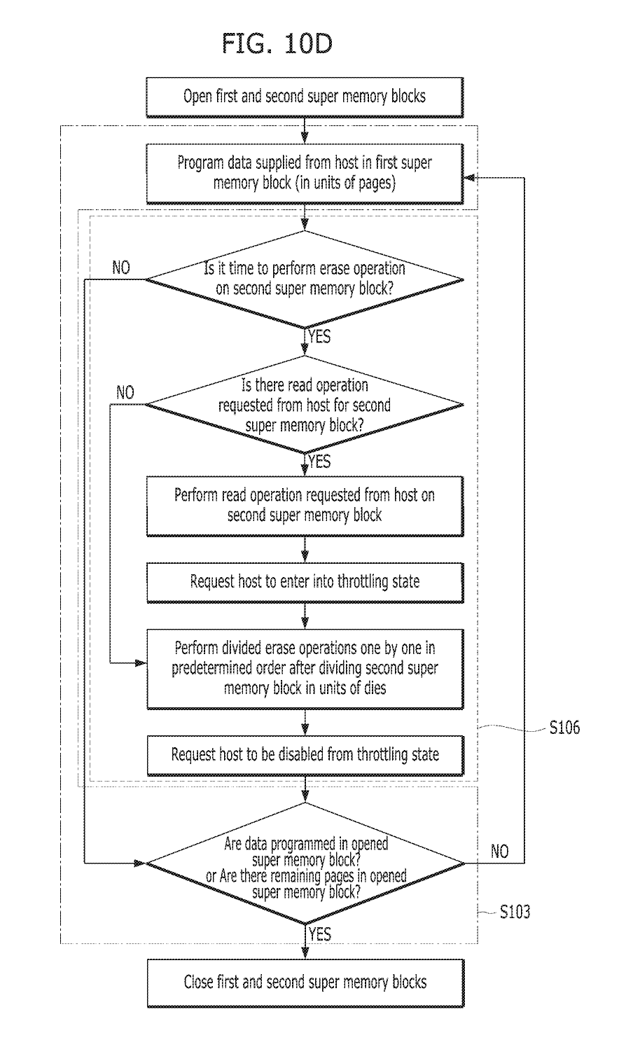

Once the command operation starts to be performed on one super memory block when the command operation is performed on the memory blocks BLOCK<001, 011, 101, 111, 201, 211, 301, 311/002, 012, 102, 112, 202, 212, 302, 312 /003, 013, 103, 113, 203, 213, 303, 313/ . . . > grouped in units of the super memory blocks SB<0:3 . . . >, the controller 130 shown in FIG. 7 may not perform the command operation on another super memory block until the command operation on the one super memory block is completed. That is, the controller 130 may sequentially perform the command operations on the respective super memory blocks SB<0:3 . . . >, which are selected one by one, while operating as shown in a flowchart of FIG. 10A.

For example, the controller 130 may designate the moment ranging from t0 to tn−1 as a time period to perform the program operation on the first super memory block SB1 and may queue continuously the “n” program commands PGM (SB1, P<0:n−1>) for the first super memory block SB1 in the command queues QD<0:3> in step S101. Similarly, the controller 130 may designate the to moment as a time period to perform the erase operation on the second super memory block SB2 and may queue the erase command ERS (532) for the second super memory block SB2 in the command queues QD<0:3> in step S102. The controller 130 may not queue the erase command ERS (SB2) for the second super memory block 532 in the command queues QD<0:3> if the second super memory block SB2 is free in step S102. Besides, the controller 130 may designate the tn+1 moment to a specific moment as a time period to perform the program operation on the second super memory block SB2 and may queue continuously the program commands PGM (532, P<0: . . . >) for the second super memory block SB2 in the command queues QD<0:3> in step S101.

As described above, the controller 130 may control each of the command operations not to overlap each other by selecting the plurality of memory dies DIE<0:3> in parallel in order to process the command operations in units of the super memory blocks SB<0:3 . . . >.

However, in case that the command operation which takes a relatively long time, for example, the erase operation which takes a long time relatively to the read/program operations starts when the controller 130 performs the command operations as described above, the controller 130 may not perform other operations on the memory device 150 at all for a relatively long duration that is required until the erase operation is completed.

In addition, when the controller 130 performs the command operations as described above, it may cause a great increase in peak current of the memory device 150 because the memory dies DIE<0:3> are selected in parallel and starts the erase operation at the substantially same moment.

In case of the program operation, the memory dies DIE<0:3> may start the program operation only if the controller 130 transmits program data (not illustrated) after transmitting the program commands PGM (SB1, P<0:n−1>) to the memory dies DIE<0:3>. For this reason, even when the memory dies DIE<0:3> are selected in parallel and starts the program operation, moments when the program data are transmitted to each of the memory dies DIE<0:3> may be dispersed. This means that moments when the program operation starts in each of the memory dies DIE<0:3> may be dispersed. In case of the read operation, the read operation itself may consume relatively small current. However, in case of the erase operation, moments when the controller 130 transmits erase commands ERS (SB2_D) to the memory dies DIE<0:3> may be moments when each of the memory dies DIE<0:3> starts the erase operation. When the controller 130 performs the command operations on the memory dies DIE<0:3> that are selected in parallel, the performance of the erase operation relative to the program/read operations may cause a greater increase in the peak current.

Accordingly, in case of the erase operation which takes a relatively long time and greatly increases the peak current, the controller 130 may perform the command operations as shown in FIG. 8.

As described above, the memory blocks BLOCK<001, 011, 101, 111, 201, 211, 301, 311 /002, 012, 102, 112, 202, 212, 302, 312/003, 013, 103, 113, 203, 213, 303, 313/ . . . > grouped in units of the super memory blocks SB<0:3 . . . > may be selected in parallel in order to perform the command operations at the moments such as t0, t1, t2, . . . . That is, the memory blocks BLOCK<001, 011, 101, 111, 201, 211, 301, 311/002, 012, 102, 112, 202, 212, 302, 312 /003, 013, 103, 113, 203, 213, 303, 313 / . . . > grouped in units of the super memory blocks SB<0:3 . . . > may be substantially simultaneously selected through the interleaving scheme as described above with reference to FIG. 6, for example, the channel interleaving scheme, the memory die interleaving scheme, the memory chip interleaving scheme or the way interleaving scheme.

Referring to FIG. 8, the controller 130 may verify that the erase operation is performed in parallel on the second super memory block SB2 in a period where the program operation that includes “M” super block page unit programs is performed on the first super memory block SB1.

The controller 130 may verify whether the erase operation is necessary to be performed on the second super memory block SB2 in the period where the program operation is performed on the first super memory block SB1. For example, the controller 130 may perform the program operation on two or more super memory blocks including the first super memory block SB1 according to a request of the host 102. In this case, the controller 130 may verify whether the program operation is necessary to be performed on a super memory block, for example, the second super memory block SB2 to be selected and programmed after the program operation on the first super memory block SB1 is completed in the period where the program operation is performed on the first super memory block SB1. Whether the number of super memory blocks of a free state among the super memory blocks SB<0:3 . . . > is equal to or less than a predetermined number may be a standard of the controller 130 to determine whether the erase operation is necessary to be performed on the second super memory block SB2.

In this manner, since the controller 130 may verify whether the erase operation is necessary to be performed on the second super memory block SB2 in the period where the program operation is performed on the first super memory block SB1, the erase operation may be performed in parallel on the second super memory block SB2 in the period where the program operation is performed on the first super memory block SB1, as shown in a flowchart of FIG. 10B.

In step S103, the program operation is performed on the first super memory block SB1 and in step S104, the erase operation may be performed in parallel on the second super memory block SB2.

When the erase operation is performed in parallel on the second super memory block SB2 in the period where the program operation is performed on the first super memory block SB1, the controller 130 may verify whether the read operation for the second super memory block SB2 is requested by the host 102 before the erase operation starts to be performed on the second super memory block SB2 and may select and perform any one of the following two operations as a result of the verification.

In step S105, a first operation is when the controller 130 verifies that the read operation for the second super memory block SB2 is requested by the host 102, the read operation for the second super memory block SB2 may be completed while the program operation for the first super memory block SB1 is paused. Subsequently, in step S105, the paused program operation for the first super memory block SB1 may resume, and the erase operation may be performed in parallel on the second super memory block SB2 in a period where the program operation for the first super memory block SB1 continues. That is, in the first operation, the controller 130 may operate as shown in a flowchart of FIG. 10C.

In step S106, a second operation is when the controller 130 verifies that the read operation for the second super memory block SB2 is requested by the host 102, the read operation for the second super memory block SB2 may be completed while the program operation for the first super memory block SB1 is paused. When the paused program operation for the first super memory block SB1 may resume, the controller 130 may request the host 102 to enter into a throttling state. Subsequently, in step S106, the erase operation may be performed in parallel on the second super memory block SB2 in the period where the program operation for the first super memory block SB1 continues, and after the erase operation is completed, the controller 130 may request the host 102 to exit from the throttling state. When the host 102 enters into the throttling state, the host 102 may determine that the memory system 110 is busy and may operate to decrease frequency of commands requested to the memory system 110. That is, in the second operation, the controller 130 may operate as shown in a flowchart of FIG. 10D.

The program operation for the first super memory block SB1 may include “M” program operations for “M” pages for each die of the first super memory block SB1. This may mean that when the program operations are performed on the first memory blocks BLOCK<001, 011, 101, 111, 201, 211, 301, 311> grouped into the first super memory block SB1 “M” times by units of pages for each die of the first super memory block SB1, the program operation for the first super memory block SB1 is completed. In other words, the controller 130 may generate “M” program commands PGM (SB1, P<0:M−1>) for each die of the first super memory block SB1 and queue the commands in parallel in the command queues QD<O:3> in order to perform the program operation on “M” pages P<O:M−1> for each die of the first super memory block SB1. When the program operation is performed on the first memory blocks BLOCK<001, 011, 101, 111, 201, 211, 301, 311> grouped into the first super memory block SB1 the “M” times for each die of the first super memory block SB1 in response to the “M” program commands PGM (SB1, P<0: M−1>) for each die of the first super memory block SB1, the program operation for the first super memory block SB1 may be completed.

Further, the erase operation may be performed on the second memory blocks BLOCK<002, 012, 102, 112, 202, 212, 302, 312> grouped into the second super memory block SB2 by units of memory blocks for each die of the second super memory block SB2 so that the erase operation for the second super memory block may be completed. In other words, the controller 130 may generate the erase command ERS (SB2) for each die of the second super memory block SB2 and queue the command in parallel in the command queues QD<0:3> in order to perform the erase operation on each of the second memory blocks BLOCK<002, 012, 102, 112, 202, 212, 302, 312> grouped into the second super memory block SB2. When the erase operation is performed on the second memory blocks BLOCK<002, 012, 102, 112, 202, 212, 302, 312> grouped into the second super memory block SB2 one by one in response to the erase command ERS (SB2) for each die of the second super memory block SB2, the erase operation for the second super memory block SB2 may be completed.

Accordingly, the fact that the controller 130 performs the erase operation in parallel on the second super memory block SB2 in the period where the program operation is performed on the first super memory block SB1 may mean that the controller 130 queues the “M” program commands PGM (SB1, P<0: M−1>) for each die of the first super memory block SB1 for performing the program operation on the first super memory block SB1 and the erase command ERS (SB2) for each die of the second super memory block SB2 for performing the erase operation on the second super memory block SB2 in parallel in the command queues QD<0:3>, as shown in FIG. 8.

In this manner, the controller 130 may operate as described below in order to queue the “M” program commands PGM (SB1, P<0: M−1>) and the erase command ERS (SB2) in parallel in the command queues QD<0:3>, as shown in FIG. 8.

In order to queue the “M” program commands PGM (SB1, P<0:M−1>) for each die of the first super memory block SB1 in parallel in the command queues QD<0:3>, an area for queueing “M” commands in each of the command queues QD<0:3> for each die of the first super memory block SB1 may be required. In other words, if it is represented by a “moment”, considering that the command queues QD<0:3> operate in a First-In First-Out (FIFO) method, successive “M” moments may be required to queue the “M” program commands PGM (SB1, P<0:M−1>) for each die of the first super memory block SB1 in parallel in the command queues Q©<0:3>.

Similarly, in order to queue the erase command ERS (SB2) for each die of the second super memory block SB2 in parallel in the command queues QD<0:3>, an area for queueing one command in each of the command queues QD<0:3> for each die of the second super memory block SB2 may be required. In other words, one moment may be required to queue the erase command ERS (SB2) for each die of the second super memory block SB2 in parallel in the command queues QD<O:3>.

Consequently, successive M+1 moments may be required to queue the “M” program commands PGM (SB1, P<0:M−1>) for each die of the first super memory block SB1 and the erase command ERS (SB2) for each die of the second super memory block SB2 in parallel in the command queues QD<0:3>. As shown in FIG. 8, the controller 130 may queue the “M” program commands PGM (SB1, P<O:M−1>) for each die of the first super memory block SB1 and the erase command ERS (SB2) for each die of the second super memory block SB2 in parallel in the command queues QD<0:3> during successive M+1 moments.

Moreover, the controller 130 shown in FIG. 8, differently from the controller 130 shown in FIG. 7, may not queue the erase command ERS (532) for each die of the second super memory block SB2 in the command queues QD<0:3> at the same moment. The controller 130 shown in FIG. 8 may generate divided erase commands ERS (SB2_D0), ERS (SB2_D1), ERS (SB2_D2) and ERS (SB2_D3) by dividing the erase command ERS (SB2) for each die of the second super memory block SB2 in units of dies, wherein the divided erase commands ERS (SB2_D0), ERS (SB2_D1), ERS (SB2_D2) and ERS (SB2_D3) correspond to the memory dies DIE<0:3> respectively and may queue the divided erase commands ERS (SB2_D0), ERS (SB2_D1), ERS (SB2_D2) and ERS (SB2_D3) in the command queues QD<0:3>respectively at different and discontinuous “N” moments tN<1:4>. That is, the controller 130 may distribute and queue the divided erase commands ERS (SB2_D0), ERS (SB2_D1), ERS (SB2_D2) and ERS (SB2_D3) at the different and discontinuous “N” moments in the command queues QD<0:3> so that the erase operation for each die of the second super memory block SB2 may be divided in units of dies and performed at the discontinuous “N” moments tN<1:4> among the successive M+1 moments t<0:M>.

In other words, the controller 130 may distribute in parallel the divided erase commands ERS (SB2_D0), ERS (5B2_D1), ERS (SB2_D2) and ERS (SB2_D3) to correspond to the “N” moments tN<1:4> for each die of the second super memory block SB2 between the “M” program commands PGM (5131, P<0:M−1>) for each die of the first super memory block SB1 and then may queue the divided erase commands ERS (SB2_D0), ERS (SB2_D1), ERS (5B2_D2) and ERS (SB2_D3) in the command queues QD<0:3> so that the erase operation which is divided in units of dies may be distributed and performed on the second super memory block SB2 in parallel at the “N” moments tN<1:4> in a period where the “M” program operations for each die of the first memory block SB1 are performed at the M+1 moments t<0:M>.

The discontinuous “N” moments tN<1:4> may be set to have a predetermined interval between the M+1 moments t<0:M>. For example, in such a way that when a predetermined number of program commands among the “M” program commands PGM (SB1, P<0:M−1>) are queued in the command queues QD<0:3>, a first divided erase command among the divided erase commands ERS (SB2_D0), ERS (SB2_D1), ERS (SB2_D2) and ERS (SB2_D3) may be queued in parallel in the command queues QD<0:3>, and then when another predetermined number of program commands are queued in the command queues QD<O:3>, a second divided erase command among the divided erase commands ERS (SB2_D0), ERS (SB2_D1), ERS (SB2_D2) and ERS (SB2_D3) may be queued in parallel in the command queues QD<0:3>, the moments when each of the divided erase commands ERS (SB2_D0), ERS (SB2_D1), ERS (SB2_D2) and ERS (SB2_D3) are queued may be set to have the predetermined interval (i.e., time for queueing the predetermined number of program commands). It may be a matter of course that it is possible to set randomly the moments when each of the divided erase commands ERS (SB2_D0), ERS (SB2_D1), ERS (SB2_D2) and ERS (SB2_D3) is queued.

Referring to FIG. 8, the controller 130 may generate the “M” program commands PGM (SB1, P<0:M−1>) to perform the program operation on the “M” pages P<0:M−1> for each die of the first memory blocks BLOCK<001, 011, 101, 111, 201, 211, 301, 311> grouped into the first super memory block SB1. Also, the controller 130 may generate the divided erase commands ERS (SB2_D0), ERS (SB2_D1), ERS (SB2_D2) and ERS (SB2_D3) for each die of the second super memory block SB2 by dividing the erase command ERS (SB2) in units of dies to perform the erase operation on each die of the second memory blocks BLOCK<002, 012, 102, 112, 202, 212, 302, 312> grouped into the second super memory block SB2. In addition, the controller 130 may distribute the divided erase commands ERS (SB2_D0), ERS (SB2_D1), ERS (SB2_D2) and ERS (SB2_D3) in parallel between the “M” program commands PGM (SB1, P<0:M−1>) for each die.

That is, the controller 130 may queue a zeroth program command PGM (SB1, PO) among the “M” program commands PGM (SB1, P<0:M−1>) for each die in parallel in the command queues QD<0:3> at a t0 moment.

Subsequently, at a t1 moment, the controller 130 may queue a first program command PGM (SB1, P1) among the “M” program commands PGM (SB1, P<0:M−1>) in the command queues QD<0, 2, 3> for the zeroth, second and third memory dies DIE<0, 2, 3>. Also, at the t1 moment, the controller 130 may queue a first divided erase command ERS (SB2_D1) for the first memory die DIE1 among the divided erase commands ERS (SB2_D0), ERS (SB2_D1), ERS (SB2_D2) and ERS (SB2_D3) in the first command queue QD1 corresponding to the first memory die DIE1.

In this manner, it may be seen that the first program command

PGM (SB1, P1) for the zeroth, second and third memory dies DIE<0, 2, 3> and the first divided erase command ERS (SB2_D1) for the first memory die DIE1 are included in parallel at the t1 moment. The t1 moment among the successive M+1 moments t<0: M> may be the same as a tN1 moment among the discontinuous “N” moments tN<1:4>.

Subsequently, at a t2 moment, the controller 130 may queue in the first command queue QD1 the first program command PGM (SB1, P1) for the first memory die DIE1, which is not queued in the first command queue QD1 at the t1 moment because the first divided erase command ERS (SB2_D1) for the first memory die DIE1 is queued therein, a second program command PGM (SB1, P2) for the second and third memory dies DIE<2, 3> among the “M” program commands PGM (SB1, P<O:M−1>) in the command queues QD<2, 3> corresponding to the second and third memory dies DIE<2, 3>, and a zeroth divided erase command ERS (SB2 . . . D0) for the zeroth memory die DIE0 among the divided erase commands ERS (SB2_D0), ERS (SB2_D1), ERS (SB_D2) and ERS (SB2_D3) in the zeroth command queue QD0 corresponding to the zeroth memory die DIE©.

In this manner, it may be seen that the first and second program commands PGM (SB1, P<1:2>) for the first memory die DIE1 and the zeroth divided erase command ERS (SB2_D0) for the zeroth memory die DIE0 are included in parallel at the t2 moment. The t2 moment among the successive M+1 moments t<0:M> may be the same as a tN2 moment among the discontinuous “N” moments tN<1:4>.

Subsequently, at a t3 moment, the controller 130 may queue in the first command queue QD1 and the zeroth command queue QD0 the second program command PGM (SB1, P2) for the first and zeroth memory dies DIE1 and DIE0, which are not queued in the first command queue QD1 and the zeroth command queue QD0 at the t2 moment because the first divided erase command ERS (SB2_D1) for the first memory die DIE1 and the zeroth divided erase command ERS (SB2_D0) for the zeroth memory die DIE0 are queued respectively in the first command queue QD1 and the zeroth command queue QD0, a third program command PGM (SB1, P3) for the second memory die DIE2 among the “M” program commands PGM (SB1, P<0:M−1>) in the command queue QD2 corresponding to the second memory die DIE2, and a third divided erase command ERS (SB2_D3) for the third memory die DIE3 among the divided erase commands ERS (SB2_D0), ERS (SB2_D1), ERS (SB2_D2) and ERS (SB2_D3) in the third command queue QD3 corresponding to the third memory die DIE3.

In this manner, it may be seen that the second and third program commands PGM (SB1, P<2:3>) for the zeroth to second memory dies DIE0 to DIE2 and the third divided erase command ERS (SB2_D3) for the third memory die DIE3 are included in parallel at the t3 moment. The t3 moment among the successive M+1 moments t<0:M> may be the same as a tN3 moment among the discontinuous “N” moments tN<1:4>.

Subsequently, at a t4 moment, the controller 130 may queue in the first command queue QD1, the zeroth command queue QD0 and the third command queue QD3, the third program command PGM (SB1, P3), which is not queued in the first command queue QD1, the zeroth command queue QD0 and the third command queue QD3 at the t3 moment because the first divided erase command ERS (SB2_D1) for the first memory die DIE1, the zeroth divided erase command ERS (SB_D0) for the zeroth memory die DE0 and the third divided erase command ERS (SB2_D3) for the third memory die DIE3 are queued respectively in the first command queue QD1, the zeroth command queue QD0 and the third command queue QD3. Also, at the t4 moment, the controller 130 may queue a fourth program command PGM (SB1, P4) for the second memory die DIE2 among the “M” program commands PGM (SB1, P<O:M−1>) in the second command queue QD2 corresponding to the second memory die DIE2. In other words, since any one of the divided erase commands ERS (SB2_D0), ERS(SB2_D1), ERS (SB2_D2) and ERS (SB2_D3) is not queued in the command queues Q©<0:3> at the t4 moment, the third program command PGM (SB1, P3) for the first, zeroth and third memory dies DIE1, DIE0 and DIE3 may be queued in the first command queue QD1, the zeroth command queue QD0 and the third command queue QD3, and the fourth program command PGM (SB1, P4) for the second memory die DIE2 may be queued in the second command queue QD2, as shown at the t3 moment.

The pattern where the program command queued in the first command queue QD1, the zeroth command queue QD0 and the third command queue QD3 is later by as much as a single queued item than the program command queued in the second command queue QD2 at each of the aforementioned t3 and t4 moments, may repeat from the t3 moment to a tM−2 moment.

Subsequently, at a tM−1 moment, the controller 130 may queue in the first command queue QD1, the zeroth command queue QD0 and the third command queue QD3, a M−2 program command PGM (SB1, PM-2) for the first, zeroth and third memory dies DIE1, DIE0 and DIE3, which is not queued in the first command queue QD1, the zeroth command queue QD0 and the third command queue QD3 at the tM−2 moment because the first divided erase command ERS (SB2_D1) for the first memory die DIE1, the zeroth divided erase command ERS (SB2_D0) for the zeroth memory die DIE0 and the third divided erase command ERS (SB2_D3) for the third memory die DIE3 are queued respectively in the first command queue QD1, the zeroth command queue QD0 and the third command queue QD3 . Also, at the tM−1 moment, the controller 130 may queue a second divided erase command ERS (SB2_D2) for the second memory die DIE2 among the divided erase commands ERS (SB2_D0), ERS (SB2_D1), ERS (SB2_D2) and ERS (SB2_D3) in the second command queue QD2 corresponding to the second memory die DIE2.

In this manner, it may be seen that the M−2 program command PGM (SB1, PM−2) for the first, zeroth and third memory dies DIE1, DIE0 and DIE3 and the second divided erase command ERS (SB2_D2) for the second memory die DIE2 are included in parallel at the tM−2 moment. The tM-2 moment among the successive M+1 moments t<0: M> may be the same as a tN4 moment among the discontinuous

“N” moments tN<1:4>.

Subsequently, at a tM moment, the controller 130 may queue in the first command queue QD1, the zeroth command queue QD0, the third command queue QD3 and the second command queue QD2, a M−1 program command PGM (SB1, PM−1) for the first, zeroth and third memory dies DIE1, DIE0 and DIE3, which is not queued in the first command queue QD1, the zeroth command queue QD0, the third command queue QD3 and the second command queue QD2 at the tM−1 moment because the first divided erase command ERS (SB2_D1) for the first memory die DIE1, the zeroth divided erase command ERS (SB2_D0) for the zeroth memory die DIE0, the third divided erase command ERS (SB2_D3) for the third memory die DIE3 and the second divided erase command ERS (SB2_D2) for the second memory die DIE2 are queued respectively in the first command queue QD1, the zeroth command queue QD0, the third command queue QD3 and the second command queue QD2.

When the controller 130 reaches the tM moment, the “M” program commands PGM (SB1, P<0:M−1>) for performing the program operation on each die of the first super memory block SB1 and the divided erase commands ERS (SB2_D0), ERS (SB2_D1), ERS (SB2_D2) and ERS (SB2_D3) for performing the erase operation on each die of the second super memory block SB2 may be queued in parallel in the command queues QD<0:3>.

Particularly, since the t1, t2, t3 and tM−1 moments among the successive M+1 moments t<0:M> between the t0 moment and the tM moment are selected as the discontinuous “N” moments tN<1:4> and then the divided erase commands ERS (SB2_D0), ERS (SB2_D1), ERS (SB2_D2) and ERS (SB2_D3) for each die of the second super memory block SB2 are distributed in the command queues QD<0:3> at the “N” moments tN<1:4>, the divided erase commands ERS (SB2_D0), ERS (SB2_D1), ERS (SB2_D2) and ERS (SB2_D3) may be distributed in parallel between the “M” program commands PGM (SB1, P<0:M−1>) for performing the program operation on each die of the first super memory block SB1 and may be queued in the command queues

QD<0:3>.

For this reason, when the commands queued in the command queues QD<0: 3> are executed in the memory device 150 until the tM moment, the program operation for each die of the first super memory block SB1 and the erase operation for each die of the second memory block SB2 may be completed.

Particularly, since the erase operation is divided and performed in units of dies on second super memory block SB2 at the “N” moments tN<1:4>, whereby each of the “N” moments tN<1:4> is overlapped with the M+1 moments t<0:M> for performing the program operation on each die of the first super memory block SB1, absolute time required for the erase operation performed on each die of the second super memory block SB2 may be reduced. That is, the absolute time required for performing the erase operation in parallel on each die of the second super memory block SB2 in the period where the program operation is performed on each die of the first super memory block SB1 as described with reference to FIG. 8 may be smaller than the absolute time required for completely separately performing the program operation on the first super memory block SB1 and the erase operation on the second super memory block SB2 as described with reference to FIG. 7.

Besides, since the erase operation is divided and performed in units of dies on second super memory block SB2 at the “N” moments tN<1:4> in the period where the program operation is performed on the first super memory block SB1, an increase in peak current of the memory device 150 due to the erase operation may be minimized.

When the erase operation is performed on each die of the second super memory block SB2 in the period where the program operation is performed on each die of the first super memory block SB1, the controller 130 may determine an order of the erase operation to the second memory blocks BLOCK<002, 012, 102, 112, 202, 212, 302, 312> grouped into the second super memory block SB2 in such ways as below.

A first way is to apply the erase operation to the second memory blocks BLOCK<002, 012, 102, 112, 202, 212, 302, 312> grouped into the second super memory block SB2 in a first predetermined order when the controller 130 operates the memory dies DIE<0:3> through the interleaving method in the first predetermined order.

For example, the controller 130 controls the memory device 150 to perform operations to the first memory die DIE1, the zeroth memory die DIE0, the third memory die DIE3, the second memory die DIE2 and then, the first memory dies DIE1 in sequential order through one among the channel interleaving scheme, the memory die interleaving scheme, the memory chip interleaving scheme and the way interleaving scheme.

In this case, the controller 130 may control the memory device 150 to perform the erase operation to the memory block BLOCK<102, 112> corresponding to the first memory die DIE1, to the memory block BLOCK<002, 012> corresponding to the zeroth memory die DIE0, to the memory block BLOCK<302, 312> corresponding to the third memory die DIE3, and then to the memory block BLOCK<202, 212>corresponding to the second memory die DIE2 in sequential order among the second memory blocks BLOCK<002, 012, 102, 112, 202, 212, 302, 312> grouped into the second super memory block SB2.

In order to apply the first way, the divided erase commands ERS (SB_D0), ERS (SB2_D1), ERS (SB2_D2) and ERS (SB2_D3) divided in units of dies to perform the erase operation on the second super memory block SB2 may be distributed between the “M” program commands PGM (SB1, P<0:M−1>) for performing the program operation on the first super memory block SB1 and may be queued in the command queues QD<0:3> so as to correspond to the first predetermined order and the “N” moments tN<1:4>.

A second way is to perform the erase operation to the second memory blocks BLOCK<002, 012, 102, 112, 202, 212, 302, 312> grouped into the second super memory block SB2 in a second predetermined order when the controller 130 manages the second predetermined order of the command queues from the smallest number of commands to the greatest number of commands.

Although it is illustrated in the drawing that just the program commands PGM (SB1, P<0:M−1>) for each die of the first super memory block SB1 and the erase commands ERS (SB2_D<0:3>) for the second super memory block SB2 are queued in the command queues QD<0:3>, more complicated forms of program commands and erase commands may be included in the command queues QD<0:3>in actuality. Thus, the controller 130 may verify the number of commands queued in each of the command queues QD<0:3> at a moment when the program operation starts to be performed on each die of the first super memory block SB1 and may manage an order of the commands as the second predetermined order.

For example, at the moment when the program operation starts to be performed on each die of the first super memory block SB1, the smallest number of commands (not illustrated) may be queued in the first command queue QD1, the second smallest number of commands (not illustrated) may be queued in the zeroth command queue QD0, the third smallest number of commands (not illustrated) may be queued in the third command queue QD3, and the greatest number of commands (not illustrated) may be queued in the second command queue QD2.

In this manner, the controller 130 may control the memory device 150 to perform the erase operation to the memory block BLOCK<102, 112> corresponding to the first memory die DIE1 which corresponds to the first command queue QD1, to the memory block BLOCK<002, 012> corresponding to the zeroth memory die DIE0 which corresponds to the zeroth command queue QD0, to the memory bloc BLOCK<302, 312> corresponding to the third memory die DIE3 which corresponds to the third command queue QD3, and then to the memory block BLOCK<202, 212> corresponding to the second memory die DIE2 which corresponds to the second command queue QD2 in sequential order among the second memory blocks BLOCK<002, 012, 102, 112, 202, 212, 302, 312> grouped into the second super memory block SB2.

In order to apply the second way, the divided erase commands ERS (SB2_D0), ERS (SB2_D1), ERS (SB2_D2) and ERS (SB2_D3) divided in units of dies to perform the erase operation on the second super memory block SB2 may be distributed between the “M” program commands PGM (SB1, P<0:M−1>) for performing the program operation on the second super memory block SB2 and may be queued in the command queues QD<0:3> so as to correspond to the second predetermined order and the “N” moments tN<1:4>.

A third way is to perform the erase operation to the second memory blocks BLOCK<002, 012, 102, 112, 202, 212, 302, 312> grouped into the second super memory block SB2 in a third predetermined order when the controller 130 manages the third predetermined order of the command queues from one having shortest expected time required for carrying out the commands on the memory dies DIE<0:3> to one having longest expected time required for carrying out the commands on the memory dies DIE<0:3>.

Although it is illustrated in the drawing that just the program commands PGM (SB1, P<0:M−1>) for each die of the first super memory block SB1 and the erase commands ERS (SB2_D<0:3>) for the second super memory block SB2 are queued in the command queues QD<0:3>, more complicated forms of program commands and erase commands may be included in the command queues QD<0:3> in actuality. Thus, the controller 130 may verify the expected time required for carrying out the commands queued in each of the command queues QD<0:3> on the memory dies DIE<0:3> at the moment when the program operation starts to be performed on each die of the first super memory block SB1 and may manage an order of the commands as the third predetermined order.

For example, at the moment when the program operation starts to be performed on each die of the first super memory block SB1, the time required for carrying out the commands queued in the first command queue QD1 on the first memory die DIE1 may be the shortest, the time required for carrying out the commands queued in the zeroth command queue QD0 on the zeroth memory die DIE0 may be the second shortest, the time required for carrying out the commands queued in the third command queue QD3 on the third memory die DIE3 may be the third shortest, and the time required for carrying out the commands queued in the second command queue QD2 on the second memory die DIE2 may be the longest.

In this manner, the controller 130 may control the memory device 150 to perform the erase operation to the memory block BLOCK<102, 112> corresponding to the first memory die DIE1 which corresponds to the first command queue QD1, to the memory block BLOCK<002, 012> corresponding to the zeroth memory die DIE0 which corresponds to the zeroth command queue QD0, to the memory bloc BLOCK<302, 312> corresponding to the third memory die DIE3 which corresponds to the third command queue QD3, and then to the memory block BLOCK<202, 212> corresponding to the second memory die DIE2 which corresponds to the second command queue QD2 in sequential order among the second memory blocks BLOCK<002, 012, 102, 112, 202, 212, 302, 312> grouped into the second super memory block SB2.

In order to apply the third way, the divided erase commands ERS (SB2_D0), ERS (SB2_D1), ERS (SB2_D2) and ERS (SB2_D3) divided in units of dies to perform the erase operation on the second super memory block SB2 may be distributed between the “M” program commands PGM (SB1, P<0:M−1>) for performing the program operation on the second memory super block SB2 and may be queued in the command queues QD<0:3> so as to correspond to the third predetermined order and the “N” moments tN<1:4>.

A fourth way is to perform the erase operation to the second memory blocks BLOCK<002, 012, 102, 112, 202, 212, 302, 312> grouped into the second super memory block SB2 in a fourth predetermined order when the controller 130 manages the fourth predetermined order of memory dies from one having the greatest number of programmed pages to one having the smallest number of programmed pages.

The number of the programmed pages in each of the memory dies DIE<0:3> may be identified through the number of program-completed pages in each of the memory dies DIE<0:3> or the number of to-be-programmed pages in each of memory dies DIE<0:3>.

For example, at the moment when the program operation starts to be performed on each die of the first super memory block SB1, the greatest number of pages included in the memory blocks BLOCK<100:103 . . . , 110:113 . . . > included in the first memory die DIE1 may be programmed, the second greatest number of pages included in the memory blocks BLOCK<000:003 . . . , 010:013 . . . > included in the zeroth memory die DIE0 may be programmed, the third greatest number of pages included in the memory blocks BLOCK<300:303 . . . , 310:313 . . . > included in the third memory die DIE3 may be programmed, and the smallest number of pages included in the memory blocks BLOCK<200:203 . . . , 210:213 . . . > included in the second memory die DIE2 may be programmed.

In this manner, the controller 130 may control the memory device 150 to perform the erase operation to the memory block BLOCK<102, 112> corresponding to the first memory die DIE1, to the memory block BLOCK<002, 012> corresponding to the zeroth memory die DIEO, to the memory bloc BLOCK<302, 312> corresponding to the third memory die DIE3, and then to the memory block BLOCK<202, 212> corresponding to the second memory die DIE2 in sequential order among the second memory blocks BLOCK<002, 012, 102, 112, 202, 212, 302, 312> grouped into the second super memory block SB2.

In order to apply the fourth way, the divided erase commands ERS (SB2_D0), ERS (SB2_D1), ERS (SB2_D2) and ERS (SB2_D3) divided in units of dies to perform the erase operation on the second super memory block SB2 may be distributed between the “M” program commands PGM (SB1, P<O:M−1>) for performing the program operation on the first super memory block SB1 and may be queued in the command queues QD<0:3> so as to correspond to the fourth predetermined order and the “N” moments tN<1:4>.

In short, the controller 130 may determine the applying order of the erase operation on the second memory blocks BLOCK<002, 012, 102, 112, 202, 212, 302, 312> grouped into the second super memory block S132 by using one among the aforementioned four ways or a combination of at least two ways when the erase operation is performed on the second super memory block SB2 in a time period where the program operation is performed on the first super memory block SB1.

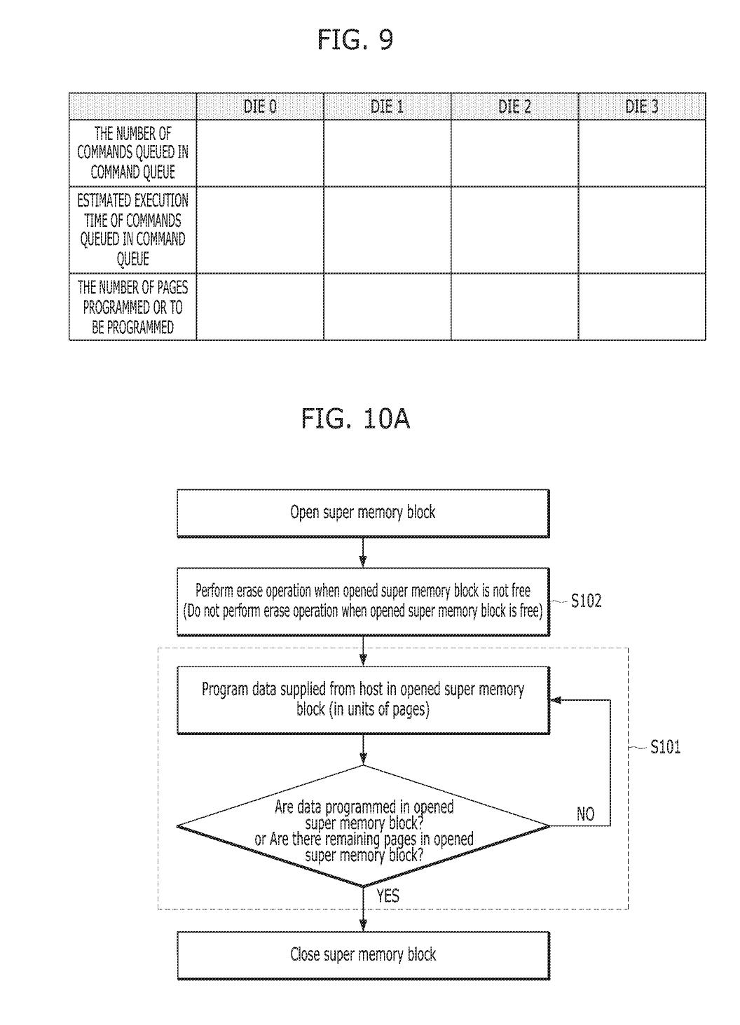

In order to manage the second to fourth ways as described above, the controller 130 may manage parameter information on each of the memory dies DIE<0:3>, i.e., information on the number of commands queued in each of the command queues QD<0:3>, information on expected time required for carrying out the commands queued in each of the command queues QD<0:3>, and information on the number of pages programmed or to be programmed in each of the memory dies DIE<0:3> through a table shown in FIG. 9.

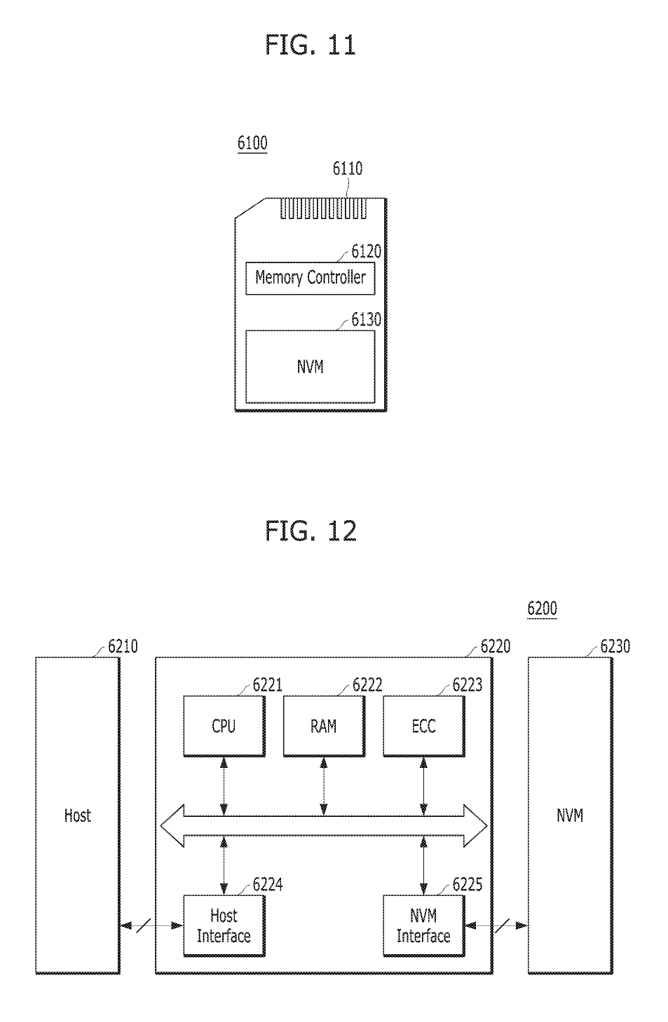

Hereafter, a data processing system and electronic devices to which the memory system 110 including the memory device 150 and the controller 130, which are described above by referring to FIGS. 1 to 10D, in accordance with the embodiment of the present invention will be described in detail with reference to FIGS. 11 to 19.

FIG. 11 is a diagram schematically illustrating another example of the data processing system including the memory system in accordance with the present embodiment. FIG. 11 schematically illustrates a memory card system to which the memory system in accordance with the present embodiment is applied.

Referring to FIG. 11, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, the memory controller 6120 may include a RAM, a processing unit, a host interface, a memory interface and an error correction unit.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express

(PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device. For example, the memory controller 6120 and the memory device 6130 may construct a solid-state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 12 is a diagram schematically illustrating another example of the data processing system including the memory system in accordance with the present embodiment.

Referring to FIG. 12, the data processing system 6200 may include a memory device 6230 having one or more nonvolatile memories and a memory controller 6220 for controlling the memory device 6230. The data processing system 6200 illustrated in FIG. 12 may serve as a storage medium such as a memory card (CF, SD, micro-SD or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 may control overall operations for the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

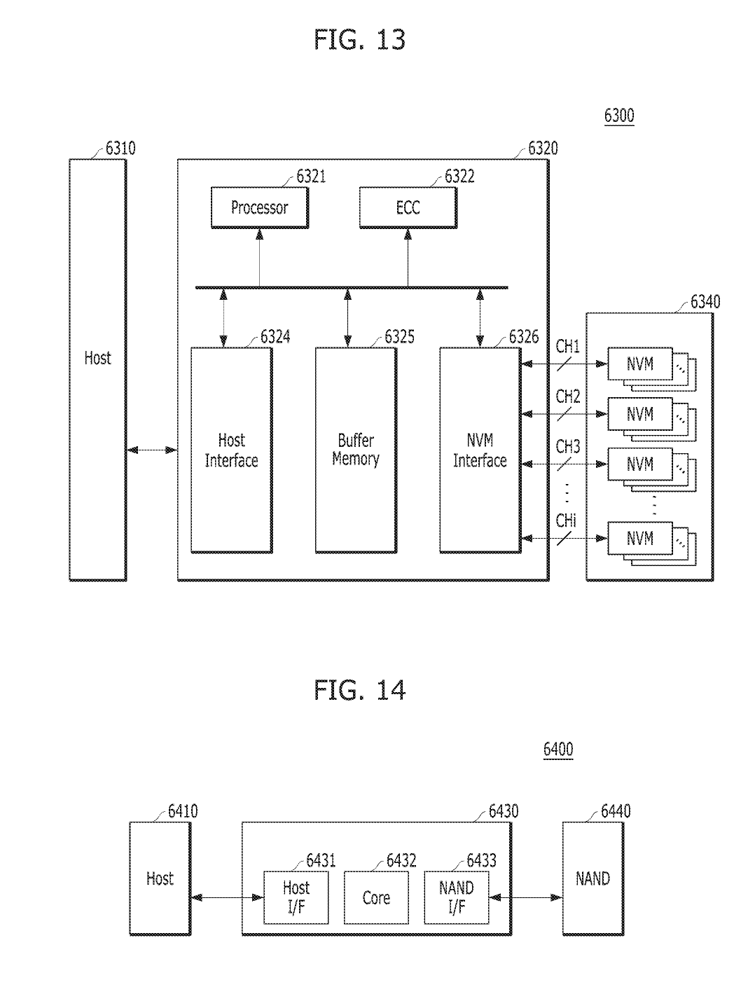

FIG. 13 is a diagram schematically illustrating another example of the data processing system including the memory system in accordance with the present embodiment. FIG. 13 schematically illustrates an SSD to which the memory system in accordance with the present embodiment is applied.

Referring to FIG. 13, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 8 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 14 is a diagram schematically illustrating another example of the data processing system including the memory system in accordance with the present embodiment. FIG. 14 schematically illustrates an embedded Multi-Media Card (eMMC) to which the memory system in accordance with the present embodiment is applied.

Referring to FIG. 14, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433 .

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

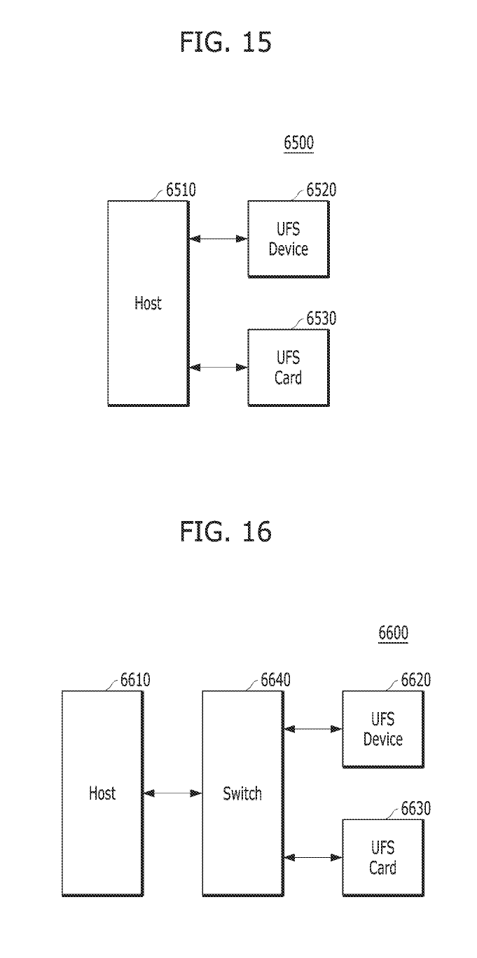

FIGS. 15 to 18 are diagrams schematically illustrating other examples of the data processing system including the memory system in accordance with the present embodiment. FIGS. 15 to 18 schematically illustrate UFS (Universal Flash Storage) systems to which the memory system in accordance with the present embodiment is applied.

Referring to FIGS. 15 to 18, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 12 to 14, and the UFS cards 6530, 6630, 6730 and 6830 may be embodied in the form of the memory card system 6100 described with reference to FIG. 11.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 15, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 16, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

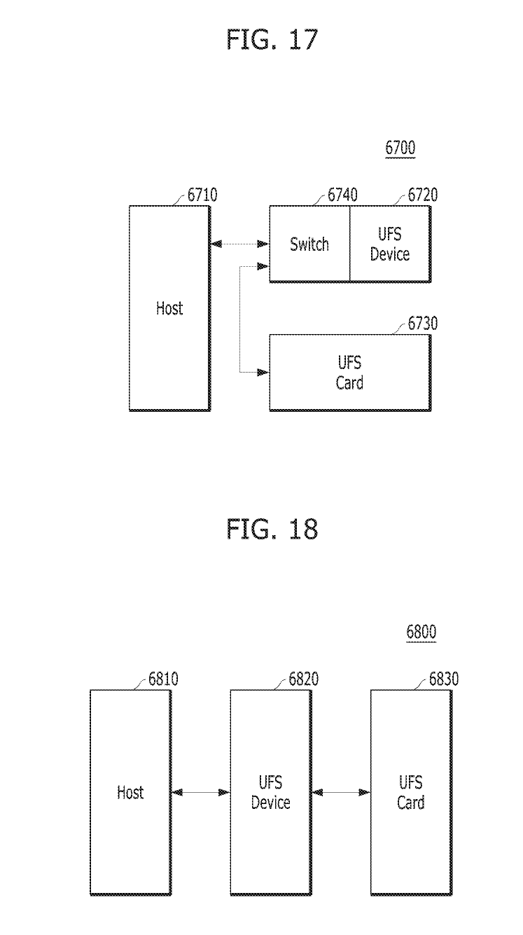

In the UFS system 6700 illustrated in FIG. 17, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 18, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

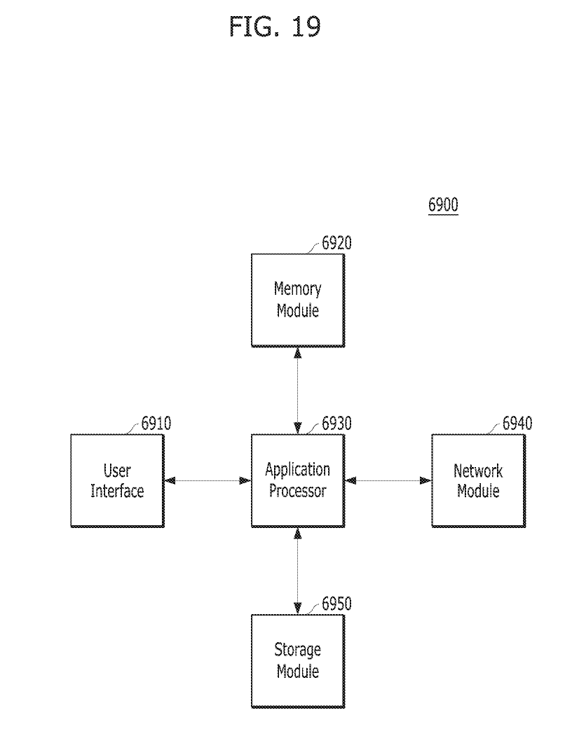

FIG. 19 is a diagram schematically illustrating another example of the data processing system including the memory system in accordance with an embodiment. FIG. 19 is a diagram schematically illustrating a user system to which the memory system in accordance with the present embodiment is applied.

Referring to FIG. 19, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 13 to 18.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a monitor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

In accordance with the present embodiments, when a plurality of memory blocks included in a memory device are managed in units of super memory blocks, an erase operation may be distributed and performed in units of dies on a second super memory block in a time period where a program operation is performed on a first super memory block. Accordingly, time delayed due to the erase operation on the super memory block may be reduced. Additionally, the size of peak current consumed due to the erase operation on the super memory block may be reduced.

While the present invention has been described with respect to specific embodiments, it will be apparent to those skilled in the art that various changes and modifications may be made without departing from the spirit and scope of the invention as defined in the following claims.

What is claimed is:

1. A memory system, comprising:
a memory device including a plurality of blocks each having a plurality of pages, a plurality of planes each having the blocks and a plurality of dies each having the planes; and
a controller suitable for managing the blocks grouped into a manner corresponding to a predetermined condition in units of super blocks,
wherein the controller includes a plurality of command queues in which commands for controlling command operations of the respective dies are stored, and
when an erase operation is performed on a second super block in a time period where a program operation including “M” super block page unit program operations is performed on a first super block, divided erase commands obtained by dividing erase commands for the second super block in units of dies are distributed and stored in locations corresponding to discontinuous “N” moments among successive M+1 moments so that the erase operation is distributed and performed on the second super block at the discontinuous “N” moments by being divided in units of dies, and
each of “M” and “N” is a natural number equal to or greater than 2, and “M” is greater than “N”.

2. The memory system of claim 1, wherein the controller distributes the divided erase commands in parallel between “M” program commands corresponding to the “M” super block page unit program operations included in the program operation of the first super block so as to correspond to the “N” moments and then stores the divided erase commands in the command queues so that the erase operation of the second super block divided in units of dies is distributed and performed in parallel between the “N” moments in the time period where the “M” super block page unit program operations included in the program operation of the first super block are performed at the M+1 moments.

3. The memory system of claim 2, wherein the controller operates the dies in a first predetermined order through an interleaving scheme, and
wherein the controller distributes the divided erase commands in parallel between the “M” program commands so as to correspond to the first predetermined order and the “N” moments, and then stores the divided erase commands in the command queues.

4. The memory system of claim 2, wherein the controller manages a second predetermined order of the command queues in which the smallest number of commands to the greatest number of commands are stored, and
wherein the controller distributes the divided erase commands in parallel between the “M” program commands so as to correspond to the second predetermined order and the “N” moments, and then stores the divided erase commands in the command queues.

5. The memory system of claim 2, wherein the controller manages a third predetermined order of the command queues whose expected time required for carrying out the commands is ranging from the shortest one to the longest one, and
wherein the controller distributes the divided erase commands in parallel between the “M” program commands so as to correspond to the third predetermined order and the “N” moments and then stores the divided erase commands in the command queues.

6. The memory system of claim 2, wherein the controller manages a fourth predetermined order of dies in which the greatest number of pages to the smallest number of pages are programmed among the dies, and
wherein the controller distributes the divided erase commands in parallel between the “M” program commands so as to correspond to the fourth predetermined order and the “N” moments and then stores the divided erase commands in the command queues.

7. The memory system of claim 1, wherein a first die among the dies is coupled to a first channel, a second die among the dies is coupled to a second channel, first planes included in the first die are coupled to a plurality of first ways sharing the first channel with each other, and second planes included in the second die are coupled to a plurality of second ways sharing the second channel with each other.

8. The memory system of claim 7, wherein the controller includes grouping a first block included in a first plane among the first planes of the first die and a second block included in a second plane among the first planes of the first die and grouping a third block included in a third plane among the second planes of the second die and a fourth block included in a fourth plane among the second planes of the second die in the predetermined condition.

9. The memory system of claim 7, wherein the controller includes grouping a first block included in a first plane among the first planes of the first die and a second block included in a second plane among the second planes of the second die and grouping a third block included in a third plane among the first planes of the first die and a fourth block included in a fourth plane among the second planes of the second die in the predetermined condition.

10. The memory system of claim 7, wherein the controller includes grouping a first block included in a first plane among the first planes of the first die, a second block included in a second plane among the first planes of the first die, a third block included in a third plane among the second planes of the second die and a fourth block included in a fourth plane among the second planes of the second die in the predetermined condition.

11. An operating method for a memory system including a memory device that includes a plurality of blocks each having a plurality of pages, a plurality of planes each having the blocks and a plurality of dies each having the planes and a plurality of command queues in which commands for controlling command operations of the respective dies are stored, the operating method, comprising:
managing the blocks grouped into a manner corresponding to a predetermined condition in units of super blocks; and
distributing and storing divided erase commands obtained by dividing erase commands for the second super block in units of dies in locations corresponding to discontinuous “N” moments among successive M+1 moments so that an erase operation is distributed and performed on a second super block at the discontinuous “N” moments by being divided in units of dies when the erase operation is performed on the second super block in a time period where a program operation including “M” super block page unit program operations is performed on a first super block,
wherein each of “M” and “N” is a naturalnumber equal to or greater than 2, and “M” is greater than “N”.

12. The operating method of claim 11, wherein the distributing and storing of the divided erase commands includes distributing the divided erase commands in parallel between “M” program commands corresponding to the “M” super block page unit program operations included in the program operation of the first super block so as to correspond to the “N” moments and then storing the divided erase commands in the command queues so that the erase operation of the second super block divided in units of dies is distributed and performed in parallel between the “N” moments in the time period where the “M” super block page unit program operations included in the program operation of the first super block are performed at the M+1 moments.

13. The operating method of claim 12, further comprising:
operating the dies in a first predetermined order through an interleaving scheme, and
wherein the distributing and storing of the divided erase commands includes distributing the divided erase commands in parallel between the “M” program commands so as to correspond to the first predetermined order and the “N” moments and then storing the divided erase commands in the command queues.

14. The operating method of claim 12, further comprising:
managing a second predetermined order of the command queues in which the smallest number of commands to the greatest number of commands are stored, and
wherein the distributing and storing of the divided erase commands includes distributing the divided erase commands in parallel between the “M” program commands so as to correspond to the second predetermined order and the “N” moments and then storing the divided erase commands in the command queues.

15. The operating method of claim 12, further comprising:
managing a third predetermined order of the command queues whose expected time required for carrying out the commands is ranging from the shortest one to the longest one, and
wherein the distributing and storing of the divided erase commands includes distributing the divided erase commands in parallel between the “M” program commands so as to correspond to the third predetermined order and the “N” moments and then storing the divided erase commands in the command queues.

16. The operating method of claim 12, further comprising:
managing a fourth predetermined order of dies in which the greatest number of pages to the smallest number of pages are programmed among the dies, and
wherein the distributing and storing of the divided erase commands includes distributing the divided erase commands in parallel between the “M” program commands so as to correspond to the fourth predetermined order and the “N” moments and then storing the divided erase commands in the command queues.

17. The operating method of claim 11, wherein a first die among the dies is coupled to a first channel, a second die among the dies is coupled to a second channel, first planes included in the first die are coupled to a plurality of first ways sharing the first channel with each other, and second planes included in the second die are coupled to a plurality of second ways sharing the second channel with each other.

18. The operating method of claim 17, wherein the predetermined condition includes grouping a first block included in a first plane among the first planes of the first die and a second block included in a second plane among the first planes of the first die and grouping a third block included in a third plane among the second planes of the second die and a fourth block included in a fourth plane among the second planes of the second die in the predetermined condition.

19. The operating method of claim 17, wherein the predetermined condition includes grouping a first block included in a first plane among the first planes of the first die and a second block included in a second plane among the second planes of the second die and grouping a third block included in a third plane among the first planes of the first die and a fourth block included in a fourth plane among the second planes of the second die in the predetermined condition.

20. The operating method of claim 17, wherein the predetermined condition includes grouping a first block included in a first plane among the first planes of the first die, a second block included in a second plane among the first planes of the first die, a third block included in a third plane among the second planes of the second die and a fourth block included in a fourth plane among the second planes of the second die in the predetermined condition.
